(19) United States
(12) Patent Application Publication
(10) Pub. No.: US 2024/0358593 A1
(43) Pub. Date: Oct. 31, 2024

(54) DEVICES, SYSTEMS, AND METHODS FOR COMBINING AND/OR DELIVERING INJECTABLE MATERIALS

(71) Applicants: BOSTON SCIENTIFIC SCIMED, INC., MAPLE GROVE, MN (US); BOSTON SCIENTIFIC MEDICAL DEVICE LIMITED, Galway (IE)

(72) Inventors: Nitesh Ghananil Baviskar, Kalyan West (IN); Benjamin Cleveland, Bellingham, MA (US); Sanjay Kumar Chandra, Pune (IN); Katie Knowles, Providence, RI (US); Junaid Mohammed Shaikh, Surat (IN)

(73) Assignees: BOSTON SCIENTIFIC SCIMED, INC., MAPLE GROVE, MN (US); BOSTON SCIENTIFIC MEDICAL DEVICE LIMITED, Galway (IE)

(21) Appl. No.: 18/646,327

(22) Filed: Apr. 25, 2024

Related U.S. Application Data
(60) Provisional application No. 63/462,119, filed on Apr. 26, 2023.

(51) Int. Cl. A61J 1/20

(52) U.S. Cl. CPC A61J 1/2089; A61J 1/201; A61J 1/2062

(57) ABSTRACT

Devices, systems, and methods for combining and/or delivering an injectable material to a patient. A vial adaptor is configured to fluidly couple at least a first chamber and a separate chamber and to facilitate fluid exchange therebetween as well as to vent the separate chamber as material is withdrawn therefrom. The first chamber may be defined in a multi-chamber device which further defines a second chamber. The vial adaptor further defines a purge reservoir into which excess material and/or air may be purged from the second chamber. For instance, as material is ejected from the first chamber into the separate chamber, a determined amount of material may be purged from the second chamber into the purge reservoir.

### CROSS-REFERENCE TO RELATED APPLICATIONS

This application claims the benefit of priority under 35 U.S.C. § 119 to U.S. Provisional Application No. 63/462,119, filed Apr. 26, 2023, the entire disclosure of which is hereby incorporated by reference herein for all purposes.

### FIELD

The present disclosure relates generally to the field of devices for delivering materials, such as injectable materials, to a patient, and associated systems and methods. More particularly, the present disclosure relates to devices for combining components of injectable materials, and associated systems and methods.

### BACKGROUND

Various forms of cancer and other medical conditions are treated by local application of radiation therapy. However, various risks may accompany radiation therapy. Since the conception of conformal radiotherapy, physicians have paid attention to the radiation dose delivered to the target and surrounding tissues. Investigators have been able to correlate side effects to the amount of tissue receiving a certain radiation dose. And yet, time, distance, and shielding affect the dose that is delivered. The less time an area is exposed to radiation, the less dose is delivered. The greater the distance from the radiation, the less dose is delivered. Filler materials may be injected into a treatment area to provide a shield to tissue surrounding the target of the radiation therapy. For instance, numerous men are diagnosed with prostate cancer each year. Traditionally, treatment options include interstitial implant therapy, surgery, and external beam radiotherapy. While the best treatment is still debatable, side effects of treating prostate cancer have become less toxic with implant therapy and radiotherapy.

Various systems provide filler material to treatment sites to decrease the radiation dose to tissue surrounding radiation target sites (e.g., to shield the rectum during radiotherapy for prostate cancer). Such filler materials are often reactive, and therefore are generally combined/mixed immediately prior to or even during delivery to the patient. Various systems are known for combining/mixing (e.g., in vitro) filler materials injected into radiation treatment areas. However, most such systems include numerous subcomponents, are complex to assemble, and are susceptible to filler mixing errors prior to delivery within a patient at a treatment site. Various challenges posed by such mixing systems may result in errors and mishaps which lead unnecessarily increased procedure time, and increased procedure costs. Solutions to these and other issues presented by combining and delivering injectable materials would be welcome in the art.

### SUMMARY

This Summary is provided to introduce, in simplified form, a selection of concepts described in further detail below in the Detailed Description. This Summary is not intended to necessarily identify key features or essential features of the claimed subject matter, nor is it intended as an aid in determining the scope of the claimed subject matter. One of skill in the art will understand that each of the various aspects and features of the present disclosure may advantageously be used separately in some instances, or in combination with other aspects and features of the disclosure in other instances, whether or not described in this Summary. No limitation as to the scope of the claimed subject matter is intended by either the inclusion or non-inclusion of elements, components, or the like in this Summary.

In accordance with various principles of the present disclosure, a vial adaptor has a proximal end configured to be fluidly coupled with a material transfer device defining a first chamber of a multi-chamber system; a distal end configured to be fluidly coupled with a separate chamber of the multi-chamber system; and a fluid exchange system defined between the vial adaptor proximal end and the vial adaptor distal end. In some aspects, the fluid exchange system has a fluid exchange lumen extending through the vial adaptor distal end to fluidly communicate the separate chamber fluidly coupled with the vial adaptor distal end with the first chamber fluidly coupled with the vial adaptor proximal end; and a venting lumen extending through the vial adaptor distal end to vent the separate chamber fluidly coupled with the vial adaptor distal end, wherein the venting lumen is fluidly isolated from the fluid exchange lumen, and fluidly communicates with a venting lumen inlet defined in a wall of the vial adaptor.

In some aspects, the proximal end of the vial adaptor defines a first port configured to receive and to be fluidly communicated with a first nozzle of the material transfer device defining the first chamber of the multi-chamber system, whereby the fluid exchange lumen is fluidly communicated with the first chamber of the multi-chamber system via the vial adaptor first port and the material transfer device first nozzle; and the distal end of the vial adaptor defines a vial-receiving chamber configured to receive a vial defining the separate chamber of the multi-chamber system. In some aspects, the fluid exchange lumen and the venting lumen are defined in a vial adaptor base portion; and the vial-receiving chamber extends distally from the vial adaptor base portion to define a vial-receiving chamber sized to receive the body of the vial defining the separate chamber. In some aspects, the vial adaptor further includes a fluid exchange device having a fluid exchange device base portion; a fluid exchange spike extending distally from the fluid exchange device base portion and defining the fluid exchange lumen therethrough with a distal end of the fluid exchange lumen extending through the fluid exchange spike to be positioned within the vial-receiving chamber and a proximal end of the fluid exchange lumen extending through the fluid exchange device base portion; and a distal extension extending distally from the fluid exchange device base portion and defining the venting lumen therethrough with a venting outlet positioned distal to the distal end of the fluid exchange lumen in the fluid exchange spike. In some aspects, the vial adaptor base portion defines a fluid exchange channel forming a base fluid exchange lumen with the fluid exchange device base portion, and a venting channel forming a base venting lumen with the fluid exchange device base portion; the base fluid exchange lumen is in fluid communication with the fluid exchange lumen and the first port defined in the proximal end of the vial adaptor; and the base venting lumen is in fluid communication with the venting lumen and the venting lumen inlet. In some aspects, the distal extension of the fluid exchange device has a sharp distal end for piercing a stopper of the vial defining the separate chamber to facilitate passage of the fluid exchange spike through the vial stopper and into the separate chamber, and the venting outlet of the fluid exchange device distal extension is defined in the sharp distal tip of the fluid exchange device distal extension. In some aspects, the vial adaptor further comprises a fluid exchange nozzle and a venting nozzle extending distally from the vial adaptor distal end and configured to be fluidly coupled with a fluid exchange port and a venting port, respectively, defined in a stopper of the vial received in the vial-receiving chamber; the fluid exchange lumen extends through the fluid exchange nozzle to fluidly communicate with the separate chamber; and the venting lumen extends through the venting nozzle to fluidly communicate with a distal extension extending within the separate chamber distally beyond the fluid exchange port in the vial stopper.

In some aspects, the proximal end of the vial adaptor defines a second port configured to receive and to be fluidly communicated with a second nozzle of the material transfer device; and the vial adaptor further includes a purge reservoir in fluid communication with the second port, whereby material from a second chamber defined in the material transfer device may be fluidly communicated, via the second nozzle and the second port, with the purge reservoir. In some aspects, the purge reservoir is defined in a vial adaptor base portion and is fluidly isolated from the fluid exchange lumen and the venting lumen. In some aspects, the vial adaptor further includes a reservoir cap positioned adjacent the proximal end of the vial adaptor and enclosing the purge reservoir within the vial adaptor; and the purge reservoir is fluidly isolated from the fluid exchange lumen and the venting lumen.

In accordance with various principles of the present disclosure, a multi-chamber combining and/or delivery system includes a material transfer device defining a first chamber therein; and a vial adaptor defining a vial-receiving chamber. In some aspects, the vial adaptor has a proximal end defining a first nozzle port; the multi-chamber device has a first nozzle configured to be fluidly coupled with the first vial adaptor nozzle port; the vial adaptor has a distal end defining a fluid exchange lumen fluidly communicating with the first vial adaptor nozzle port and the first multi-chamber device nozzle; and the vial adaptor distal end further defines a venting lumen fluidly isolated from the fluid exchange lumen and extending from a venting lumen inlet defined in a wall of the vial adaptor to the vial adaptor distal end.

In some aspects, the system further includes a fluid exchange device having a fluid exchange device base portion; a fluid exchange spike extending distally from the fluid exchange device base portion and defining the fluid exchange lumen therethrough with a distal end of the fluid exchange lumen extending through the fluid exchange spike to be positioned within the vial-receiving chamber and a proximal end of the fluid exchange lumen extending through the fluid exchange device base portion to fluidly communicate with the first vial adaptor nozzle port; and a distal extension extending distally from the fluid exchange device base portion and defining the venting lumen therethrough with a venting outlet positioned within the vial-receiving chamber distal to the distal end of the fluid exchange lumen in the fluid exchange spike.

In some aspects, the system further includes a vial having a vial body with an open end, and a vial stopper positioned within the vial body open end. In some aspects, the vial body defines a separate chamber positionable within the vial-receiving chamber defined by the vial adaptor; the vial stopper defines a fluid exchange port and a venting port therethrough in fluid communication with the separate chamber defined within the vial body; the vial adaptor further includes a fluid exchange nozzle extending distally from the vial adaptor distal end and configured to be fluidly coupled with the separate chamber via the vial stopper fluid exchange port, and a venting nozzle extending distally from the vial adaptor distal end and configured to be fluidly coupled with the separate chamber via the vial stopper venting port; and the vial stopper further includes a distal extension extending within the separate chamber to be positioned distal to the vial stopper fluid exchange port and within empty space within the separate chamber when the vial is inverted and material is withdrawn therefrom through the vial stopper fluid exchange port.

In some aspects, the proximal end of the vial adaptor further defines a second nozzle port; the multi-chamber device further defines a second chamber therein; and the multi-chamber device has a second nozzle configured to be fluidly coupled with the second vial adaptor nozzle port to fluidly communicate the second chamber with the vial adaptor. In some aspects, the vial adaptor further defines a purge reservoir fluidly coupled with the vial adaptor second nozzle port, the second multi-chamber device nozzle, and the second chamber, and fluidly isolated from the vial adaptor fluid exchange lumen, the first vial adaptor nozzle port, the first multi-chamber device nozzle, and the first chamber.

In accordance with various principles of the present disclosure, a method combines a first material contained within a first chamber and a second material contained within a separate chamber of a multi-chamber system. In some aspects, the method includes fluidly communicating the first chamber and the separate chamber via a vial adaptor; aspirating the material from the separate chamber into the first chamber via a fluid exchange lumen defined by the vial adaptor; and venting the separate chamber as material is withdrawn therefrom to equalize pressure within the separate chamber via a venting lumen defined by the vial adaptor. In some aspects, the fluid exchange lumen extends from a distal end thereof into fluid communicated with the first chamber; and the venting lumen is fluidly communicated with a venting lumen inlet defined through a wall of the vial adaptor, and has an outlet beyond the distal end of the fluid exchange lumen to be positioned within empty space within the separate chamber as material is withdrawn therefrom.

In some aspects, the method further includes ejecting the first material from the first chamber, through the fluid exchange lumen defined in the vial adaptor, and into the separate chamber. In some aspects, the vial adaptor includes a fluid exchange device having a fluid exchange spike through which the vial adaptor fluid exchange lumen is defined and a distal extension through which the vial adaptor venting lumen is defined. In some aspects, the method further includes extending the fluid exchange device fluid exchange spike through a stopper in an open end of a vial defining the separate chamber to extend a distal end of the fluid exchange lumen, defined in the fluid exchange spike, into the separate chamber; and extending the distal extension further into the separate chamber than the distal end of the fluid exchange lumen is extended to fluidly communicate the venting lumen defined with empty space created within the separate chamber as material is withdrawn therefrom.

In some aspects, the method further includes fluidly coupling a fluid exchange nozzle extending distally from a distal end of the vial adaptor into a fluid exchange port defined in a stopper in an open end of a vial defining the separate chamber; fluidly coupling a venting nozzle extending distally from the distal end of the vial adaptor with the separate chamber via a venting port defined in the vial stopper; and fluidly coupling the venting nozzle with empty space within the vial via an extension extending from the vial stopper into the separate chamber toward a closed end of the vial opposite the open end of the vial.

In some aspects, the first chamber is defined in a multi-chamber device defining a second chamber; and the method further includes purging material or air from the second chamber into a purge reservoir contained within the vial adaptor.

These and other features and advantages of the present disclosure, will be readily apparent from the following detailed description, the scope of the claimed invention being set out in the appended claims. While the following disclosure is presented in terms of aspects or embodiments, it should be appreciated that individual aspects can be claimed separately or in combination with aspects and features of that embodiment or any other embodiment.

### BRIEF DESCRIPTION OF THE DRAWINGS

Non-limiting embodiments of the present disclosure are described by way of example with reference to the accompanying drawings, which are schematic and not intended to be drawn to scale. The accompanying drawings are provided for purposes of illustration only, and the dimensions, positions, order, and relative sizes reflected in the figures in the drawings may vary. For example, devices may be enlarged so that detail is discernable, but is intended to be scaled down in relation to facilitate injection into a patient. For purposes of clarity and simplicity, not every element is labeled in every figure, nor is every element of each embodiment shown where illustration is not necessary to allow those of ordinary skill in the art to understand the disclosure. Moreover, reference characters may indicate elements in some figures which are illustrated in other figures, and which, for the sake of brevity, are described only with reference to the other figures.

The detailed description will be better understood in conjunction with the accompanying drawings, wherein like reference characters represent like elements, as follows:

FIG. 1 illustrates a perspective view of an example of an embodiment of a multi-chamber system for combining and/or delivering injectable materials to a patient formed in accordance with various principles of the present disclosure.

FIG. 2 illustrates an exploded perspective view of the multi-chamber combining and/or delivery system of FIG. 1.

FIG. 3 illustrates a perspective view of a multi-chamber combining and/or delivery system such as illustrated in FIG. 1, but with the vial fluidly coupled with the injectable material transfer device.

FIG. 4 illustrates a cross-sectional view along line IV-IV of the system illustrated in FIG. 1.

FIG. 5 illustrates a cross-sectional view along line V-V of the system illustrated in FIG. 3.

FIG. 6 illustrates a cross-sectional view, along line VI-VI of the system illustrated in FIG. 3.

FIG. 7 illustrates a perspective view of an example of an embodiment of a vial adaptor of a multi-chamber combining and/or delivery system as illustrated in FIG. 1-FIG. 6.

FIG. 8 illustrates a perspective view of another example of an embodiment of a multi-chamber combining and/or delivery system formed in accordance with various principles of the present disclosure with a protective cap positioned within the vial adapter.

FIG. 9 illustrates a cross-sectional view along line IX-IX of the system illustrated in FIG. 8.

FIG. 10 illustrates a perspective view of a multi-chamber combining and/or delivery system such as illustrated in FIG. 8, but with a vial, rather than a protective cap, positioned within the vial adaptor and fluidly coupled with the injectable material transfer device.

FIG. 11 illustrates a cross-sectional view along line XI-XI of the system illustrated in FIG. 10.

FIG. 12 illustrates a cross-sectional view along line XII-XII of the system illustrated in FIG. 10.

FIG. 13A illustrates a perspective view of the vial of FIG. 10 prior to coupling with an injectable material transfer device of the multi-chamber combining and/or delivery system illustrated in FIG. 8.

FIG. 13B illustrates a perspective view of the vial of FIG. 13A with the protective cap removed.

FIG. 14A illustrates an example of an embodiment of a valve seal in a sealing position,

FIG. 14B illustrates the valve seal of FIG. 14A in a purge position.

FIG. 15A illustrates an example of an embodiment of a valve seal in a sealing position,

FIG. 15B illustrates the valve seal of FIG. 15A in a purge position.

FIG. 16A illustrates an example of an embodiment of a valve seal in a sealing position,

FIG. 16B illustrates the valve seal of FIG. 16A in a purge position.

### DETAILED DESCRIPTION

The following detailed description should be read with reference to the drawings, which depict illustrative embodiments. It is to be understood that the disclosure is not limited to the particular embodiments described, as such may vary. All apparatuses and systems and methods discussed herein are examples of apparatuses and/or systems and/or methods implemented in accordance with one or more principles of this disclosure. Each example of an embodiment is provided by way of explanation and is not the only way to implement these principles but are merely examples. Thus, references to elements or structures or features in the drawings must be appreciated as references to examples of embodiments of the disclosure, and should not be understood as limiting the disclosure to the specific elements, structures, or features illustrated. Other examples of manners of implementing the disclosed principles will occur to a person of ordinary skill in the art upon reading this disclosure. In fact, it will be apparent to those skilled in the art that various modifications and variations can be made in the present disclosure without departing from the scope or spirit of the present subject matter. For instance, features illustrated or described as part of one embodiment can be used with another embodiment to yield a still further embodiment. Thus, it is intended that the present subject matter covers such modifications and variations as come within the scope of the appended claims and their equivalents.

It will be appreciated that the present disclosure is set forth in various levels of detail in this application. In certain instances, details that are not necessary for one of ordinary skill in the art to understand the disclosure, or that render other details difficult to perceive may have been omitted. The terminology used herein is for the purpose of describing particular embodiments only, and is not intended to be limiting beyond the scope of the appended claims. Unless defined otherwise, technical terms used herein are to be understood as commonly understood by one of ordinary skill in the art to which the disclosure belongs. All of the devices and/or methods disclosed and claimed herein can be made and executed without undue experimentation in light of the present disclosure.

As used herein, “proximal” refers to the direction or location closest to the user (medical professional or clinician or technician or operator or physician, etc., such terms being used interchangeably herein without intent to limit, and including automated controller systems or otherwise), etc., such as when using a device (e.g., introducing the device into a patient, or during implantation, positioning, or delivery), and/or closest to a delivery device, and “distal” refers to the direction or location furthest from the user, such as when using the device (e.g., introducing the device into a patient, or during implantation, positioning, or delivery), and/or closest to a delivery device. “Longitudinal” means extending along the longer or larger dimension of an element. A “longitudinal axis” extends along the longitudinal extent of an element, though is not necessarily straight and does not necessarily maintain a fixed configuration if the element flexes or bends, and “axial” generally refers to along the longitudinal axis. However, it will be appreciated that reference to axial or longitudinal movement with respect to the above-described systems or elements thereof need not be strictly limited to axial and/or longitudinal movements along a longitudinal axis or central axis of the referenced elements. “Central” means at least generally bisecting a center point and/or generally equidistant from a periphery or boundary, and a “central axis” means, with respect to an opening, a line that at least generally bisects a center point of the opening, extending longitudinally along the length of the opening when the opening comprises, for example, a tubular element, a channel, a cavity, or a bore. As used herein, a “lumen” or “channel” or “bore” or “passage” is not limited to a circular cross-section. As used herein, a “free end” of an element is a terminal end at which such element does not extend beyond. It will be appreciated that terms such as at or on or adjacent or along an end may be used interchangeably herein without intent to limit unless otherwise stated, and are intended to indicate a general relative spatial relation rather than a precisely limited location.

Various medical procedures involve delivery (e.g., injection) of injectable material(s) into the body before, during, or after the procedure. Preferably, the injectable material is biocompatible, and optionally biodegradable. The injectable material may serve a variety of purposes, including, without limitation, differentiating tissue (e.g., by creating a “bleb” or other raised or swelled region to distinguish an anatomical region), spacing anatomical structures from one another, otherwise affecting (e.g., shielding, coating, covering, modifying, etc.) an anatomical structure, etc. It will be appreciated that the term “tissue” is a broad term that encompasses a portion of or site within a body: for example, a group of cells, a group of cells and interstitial matter, an organ, a portion of an organ, an anatomical portion of a body, e.g., a rectum, ovary, prostate, nerve, cartilage, bone, brain, or portion thereof, etc. Moreover, reference may be made, herein, to a “target” in referring to an area of the patient's body at which a procedure is to be performed. However, it will be appreciated that such reference is to be broadly understood and is not intended to be limited to tissue or to particular procedures. Finally, reference may be made to target tissue, target location, target site, target tissue site, anatomical site, delivery site, deployment site, injection site, treatment site, etc., including combinations thereof and other grammatical forms thereof, interchangeably and without intent to limit.

Certain specific aspects of the present disclosure relate to preparing an injectable material for placement between target tissue to be treated and other tissues. For the sake of convenience, and without intent to limit, reference is made to an injectable material, such as a filler, including, without limitation, a gel composition. The injectable material may be delivered within the patient to displace the tissue relative to a tissue that is to be treated by a therapeutic procedure or otherwise (e.g., not necessarily therapeutic). The injectable material may displace and/or shield a tissue to protect the tissue against possible side effects of treatment of a target tissue, such as the effects of a treatment involving radiation or cryotherapy. In some aspects, the injectable material may displace anatomical tissue and/or may increase the distance between the target tissue and other tissues. For instance, if the target tissue is to be irradiated, the injectable material may space other tissues from the target tissue so that the other tissues are exposed to less radiation and/or are shielded from the radiation. In some aspects, the injectable material is injectable as a filler in a space between tissues. A first tissue may then be treated by radiation, while the injectable material reduces passage of radiation therethrough into a second tissue. The first tissue may be irradiated while the second tissue, spaced by the injectable material, receives less radiation than it would have in the absence of the injectable material. An effective amount of an injectable material may be injected into a space between a first tissue to be treated and a second tissue which can be a critically sensitive organ. For instance, in the context of treatment of prostate cancer, an injectable material may be injected into the Denonvilliers' space (a region between the rectum and prostate) to create additional space between the rectum and prostate and/or to shield the rectum during treatment, thereby reducing rectal radiation dose and associated side effects.

In some aspects of the present disclosure, components of an injectable material are combined by a system formed in accordance with various principles of the present disclosure, for injection into or near a target site. It will be appreciated that terms such as combine, mix, blend, etc., (including other grammatical forms thereof) may be used interchangeably herein without intent to limit unless otherwise indicated. Reference is accordingly made herein to a combining system generically, without intent to specifically require active combining/mixing.

In accordance with various principles of the present disclosure, the injectable material may be a filler such as a hydrophilic polymer, a gel, a hydrogel, etc. For instance, the injectable material can include polymeric materials which are capable of forming a hydrogel upon crosslinking. Optionally, the polymer forms a hydrogel within the body. A hydrogel is defined as a substance formed when a polymer (natural or synthetic) is crosslinked via covalent, ionic, or hydrogen bonds to create a three-dimensional structure which entraps water molecules to form a gel. Naturally-occurring and synthetic hydrogel-forming polymers, polymer mixtures, and copolymers may be utilized as hydrogel precursors. In some aspects, the hydrogel can be formed by a composition formed by two or more constituents/components (e.g., mixing accelerant fluid, diluent, and polyethylene glycol (PEG) together), and may include one or more polysaccharide compounds or a salt thereof. For example, the composition may include a cellulose compound such as carboxymethyl cellulose (CMC) or salt thereof (e.g., CMC sodium), xanthan gum, alginate or a salt thereof (e.g., calcium alginate, such as Ca-alginate beads), chitosan, and/or hyaluronic acid. In some examples, the composition may comprise a mixture of hyaluronic acid and CMC, and/or may be crosslinked with a suitable crosslinking compound, such as butanediol diglycidyl ether (BDDE). In some aspects, the polysaccharide may be a homopolysaccharide or a heteropolysaccharide.

In some aspects of the present disclosure, two or more components of an injectable material are provided separately, and are combined by a device, system, and method in accordance with various principles of the present disclosure to form a compound material to be injected into or near a target site by devices, systems, and methods in accordance with various principles of the present disclosure. The injectable material may be delivered within the patient to displace the tissue relative to a tissue that is to be treated by a therapeutic procedure or otherwise (e.g., not necessarily therapeutic). A composition to be injected into a patient may be a combination of two or more components combined by a device, system, or method formed in accordance with various principles of the present disclosure. For instance, devices, systems, or methods of the present disclosure may be used to combine a first component and a second component for injection into a patient. The first component may be a precursor, e.g., a first component to be combined with a second component to form the injectable compound. The second component may be an accelerator, an accelerant, an activating agent, a cross-linking inducing agent, a catalyst, an initiator, etc., which, upon combination with the precursor, produces the injectable compound, such as by altering the chemical composition or structure of the first component. The components may be combined prior to (e.g., immediately prior to or during) delivery (e.g., e.g., during injection) to the patient so that the injectable material does not have time to form into a structure which may be difficult to inject or otherwise deliver to the patient. As such, the combination of the first component and the second component may be such that the injectable compound attains its final desired properties/reaches its final form in situ.

In some embodiments, the injectable material is formed of a first component, a second component, and a third component. For instance, for various reasons it may be desirable to provide a first, precursor component in a solid form (e.g., to allow mixing at the time of delivery, and/or to be more stable for storage and/or transport). The first component is combinable with the third component, and the thus-formed combined composition (which may be referenced as the precursor) is then combinable with the second component once the medical professional is ready to deliver (e.g., inject) the injectable material to the patient. The second component may facilitate a crosslinking interaction between the first and third components, for example, by initiating or accelerating the crosslinking interaction of the first and third components. Typically, one or more of the components of the injectable materials are biocompatible polymers. In some aspects, one of the first component or third component is a reactive polymer, such as a cross-linkable and/or hydrophilic polymer component (e.g., PEG), and the other of the first component or third component is a diluent (e.g., mostly water) in which a solid or semi-solid form of the one of the first component or third component is dissolved or dispersed, and/or with which the one of the first component or third is cross-linked (or at least cross-linkable, such as upon further combination with the second component), to form a precursor. The second component may be an accelerator, an accelerant, an activating agent, a catalyst, an initiator, etc. (such terms being used interchangeably herein without intent to limit), combinable and reactive with the precursor (formed from the first component and the third component) to form the desired injectable material. In one example of an embodiment, a first component, in the form of a cross-linking agent (specifically, trilysine, which contains multiple nucleophilic groups, specifically, amino groups), is mixed with a third component, in the form of a reactive polymer (specifically, PEG) that has been derivatized with reactive, optionally electrophilic, groups (specifically, succinimide ester groups), under acidic pH conditions where the succinimide ester groups and the amino groups do not react to any significant degree. When this mixture is combined with a second component, in the form of an accelerant (specifically, a basic buffer solution), the pH of the resulting mixture becomes basic, at which point the amino groups of the trilysine react with the succinimide ester groups of the PEG to form covalent bonds, thereby crosslinking the PEG and forming a hydrogel.

It will be appreciated that reference to “first”, “second”, or “third” is not intended to connote a particular nature of the material or the order in which the material is combined. As such, “first”, “second”, and “third” may be used to reference any of three components forming an injectable material in accordance with various principles of the present disclosure. A non-limiting example of such components combinable by devices, systems, or methods in accordance with various principles of the present disclosure includes a first component such as a reactive component, a solute, etc.; a second component such as a diluent with which the reactive component is to be combined to form a precursor; and a third component such as an accelerator combinable with the precursor to form an injectable material. The injectable material is a biocompatible material, such as a polymeric material, such as a filler, or such as a hydrogel.

In some examples, the composition may be or include a gel with a desired gel strength and/or viscosity, such as a biocompatible gel suitable for injection (e.g., through a needle), as discussed in further detail below. In one example of an embodiment, the one of the components is a biocompatible polymeric component. More particularly, in one example of an embodiment, one of the components is a hydrophilic polymer, which may be natural or synthetic in origin, and may be anionic, cationic, zwitterionic, or neutrally charged. Non-limiting examples of hydrophilic polymers include natural hydrophilic polymers including proteins such as collagen and polysaccharides such as gellan gum, xanthan gum, gum arabic, guar gum, locust bean gum, alginate, and carrageenans, and synthetic hydrophilic polymers such as polyethylene glycols (PEG), PEG-methacrylates, PEG-methylmethacrylates, polyvinyl alcohols, polyacrylates and polymethacrylates, polyacrylic acids and their salts, polymethacrylic acids and their salts, polymethylmethacrylates, carboxymethylcelluloses, hydroxyethylcelluloses, polyvinylpyrrolidones, polyacrylamides such as N,N-methylene-bis-acrylamides or tris (hydroxymethyl) methacrylamides. The hydrophilic polymer may be modified to provide functional groups that are reactive with functional groups of a suitable cross-linking agent, which may be a covalent or ionic cross-linking agent.

The concentrations of gelling agent(s) in a composition formed in accordance with various principles of the present disclosure maybe at least about 0.01% by weight with respect to the total weight of the composition, and at most about 2.0% by weight with respect to the total weight of the composition, including increments of about 0.01% therebetween. For instance, the concentration of gelling agent(s) may range from about 0.02% to about 1.5%, from about 0.05% to about 1.0%, from about 0.05% to about 0.50%, from 0.05% to about 0.15%, from about 0.10% to about 0.20%, from about 0.15% to about 0.25%, from about 0.20% to about 0.30%, from about 0.25% to about 0.35%, from about 0.30% to about 0.40%, from about 0.35% to about 0.45%, from about 0.40% to about 0.50%, from about 0.1% to about 0.5%, or from about 0.1% to about 0.15% by weight with respect to the total weight of the composition. In at least one example, the total concentration of the gelling agent(s) in the composition may range from about 0.05% to about 0.5% by weight with respect to the total weight of the composition.

In some examples, a composition formed in accordance with various principles of the present disclosure may have a viscosity of at least about 0.001 pascal-second (Pa·s), and at most about 0.100 Pas at a shear rate of 130 s⁻¹. For instance, the composition may have a viscosity ranging from about 0.005 Pas to about 0.050 Pa·s, from about 0.010 Pas to about 0.050 Pa-s, from about 0.010 Pas to about 0.030 Pa·s, from about 0.010 Pa·s to about 0.020 Pa·s, from about 0.020 Pa·s to about 0.030 Pa·s, or from about 0.020 Pas to about 0.040 Pas at a shear rate of 130 s⁻¹. Thus, for example, the composition may be or comprise a gel having a viscosity of about 0.005 Pa·s, about 0.006 Pa·s, 0.008 Pa·s, about 0.010 Pa·s, about 0.011 Pas, about 0.012 Pas, about 0.013 Pa·s, about 0.014 Pa·s, about 0.015 Pa·s, about 0.016 Pa·s, about 0.017 Pas, about 0.018 Pa·s, about 0.019 Pa·s, about 0.020 Pa·s, about 0.022 Pa·s, about 0.024 Pa·s, about 0.026 Pa·s, about 0.028 Pa·s, about 0.030 Pa·s, about 0.032 Pa·s, about 0.034 Pa·s, about 0.036 Pa·s, about 0.038 Pas, about 0.040 Pa·s, about 0.042 Pa·s, about 0.044 Pa·s, about 0.046 Pa·s, about 0.048 Pas, or about 0.050 Pas at a shear rate of 130 s⁻¹. In at least one example, the composition may have a viscosity greater than 0.0050 Pas at a shear rate of 130 s⁻¹, e.g., a viscosity ranging from about 0.005 Pas to about 0.050 Pas, at a shear rate of 130 s⁻¹. In at least one example, the composition may have a viscosity greater than 0.010 Pas at a shear rate of 130 s⁻¹, e.g., a viscosity ranging from about 0.010 Pa·s to about 0.030 Pa·s, at a shear rate of 130 s⁻¹.

Alternatively or additionally, a composition formed in accordance with various principles of the present disclosure may have a viscosity of at least about 0.001 Pa-s, and at most about 0.050 Pa·s at a shear rate of 768 s⁻¹. For instance, the composition may have a viscosity ranging from about 0.002 Pa·s to about 0.030 Pa·s, from about 0.003 Pa·s to about 0.020 Pa·s, from about 0.004 Pa·s to about 0.010 Pa·s, from about 0.004 Pa·s to about 0.006 Pa·s, from about 0.005 Pa·s to about 0.007 Pa·s, from about 0.006 Pa·s to about 0.008 Pa·s, from about 0.007 Pas to about 0.009 Pa·s, or from about 0.008 Pas to about 0.01 Pas at a shear rate of 768 s⁻¹. Thus, for example, the composition may be or comprise a gel having a viscosity of about 0.003 Pa·s, about 0.004 Pa·s, about 0.005 Pa·s, about 0.006 Pa·s, about 0.007 Pa·s, about 0.008 Pas, about 0.009 Pa·s, or about 0.010 Pa·s at a shear rate of 768 s⁻¹. In at least one example, the composition may have a viscosity less than 0.010 Pa·s at a shear rate of 768 s⁻¹, e.g., a viscosity ranging from about 0.005 Pas to about 0.009 Pa·s at a shear rate of 768 s⁻¹. In at least one example, the composition may have a viscosity ranging from about 0.004 Pa·s to about 0.010 Pa·s at a shear rate of 768 s⁻¹. Further, for example, the composition may have a viscosity ranging from about 0.010 Pa·s to about 0.030 Pa·s, e.g., about 0.017 Pas at a shear rate of 130 s⁻¹ and a viscosity ranging from about 0.004 Pa·s to about 0.010 Pas, e.g., about 0.007 Pas, at a shear rate of 768 s⁻¹.

The various components forming the injectable material may be kept separate until the time of the procedure in which the final composition is used for various reasons, such as to maintain stability of the individual components. In some embodiments, a multi-chamber system includes separate chambers for components to be combined to form the injectable material to be delivered to the patient by an injection system. In some embodiments, a first component and a second component are separately contained within a first chamber and a second chamber, respectively, of a multi-chamber device. A third component may be contained in a separate device defining a third chamber of the multi-chamber system. To deliver the injectable material, the components of the first and third chambers are combined within the first chamber (e.g., to form a precursor), and then the components of the first and second chambers and injected together into the patient. The multi-chamber device may or may not mix the contents of the first chamber with the contents of the second chamber. The final form, structure, composition, properties, etc., of the injectable material may be attained once the combined components are within the patient.

The present disclosure provides devices, systems, and methods for combining components to form an injectable material, or at least a precursor for combination to form an injectable material. and corresponding medical devices, systems, and methods for use thereof and/or delivery to a treatment site of a patient. According to some aspects of the present disclosure, such as described above, a multi-chamber system may include a plurality of chambers for the one or more components of the injectable material and for combinations of such components. It will be appreciated that terms such as chamber, reservoir, container, vial, lumen, etc., may be used interchangeably herein without intent to limit, to refer to elements which contain, convey, hold, transport, collect, etc., a component (fluid, particulate, liquid, solid, gas, etc.) of an injectable material. Suitable chambers may include, for example, vials, syringes (e.g., a syringe barrel compatible with a manual or automatic injection system) and other fluid containers, such as configured for use with a suitable injection system. Examples of materials suitable for chambers of devices or systems of the present disclosure include, but are not limited to, cyclic olefin polymer, polypropylene, polycarbonate, polyvinyl chloride, and glass. In some aspects, one of these materials (e.g., cyclic olefin copolymer specifically) can have a coating applied to it (such as SiO₂ coating), which is advantageous so the coating can provide a primary oxygen barrier, behave as a glass-like layer, and/or can be applied using a vapor deposition process.

A combining device or system formed in accordance with various principles of the present disclosure to combine two or more components to form an injectable material may be removably connected to one or more injection systems which are configured to deliver the injectable materials to a patient. According to some aspects of the present disclosure, the filler compositions which may be used with various systems disclosed herein, e.g., the compositions prepared by the various devices, systems, methods disclosed herein, may have sufficient strength, e.g., gel strength, to withstand the forces on the continuity of the three-dimensional configuration (e.g., gel network) of the composition, and thereby minimize the effects of such forces. In the meantime, compositions with sufficient strength to withstand forces thereon may have a viscosity suitable for injection, e.g., a viscosity that does not cause the composition to become stuck in the reservoir(s), delivery lumen, needle, or other structure in which the composition is contained or through which it passes. According to some aspects of the present disclosure, the composition may maintain its three-dimensional structure until the composition is injected into a patient (e.g., through a needle), whereupon the structure may form fragments of the original continuous, three-dimensional network. Those fragments may have a diameter corresponding to the diameter of the lumen through which it passes into the patient (e.g., the lumen of an injection needle), such that the fragments are as large as possible in-vivo to retain as much of the three-dimensional structure of the composition as possible. Injection of these larger-sized particles or fragments is believed to increase the amount of time the gel remains within the tissue.

In some examples, the injection system includes a needle. In some embodiments, the needle may be a hypodermic needle, and may range from a size of 7-gauge (4.57 mm outer diameter (OD), 3.81 mm inner diameter (ID)) to 33-gauge (0.18 mm OD, 0.08 mm ID), e.g., a size of 16-gauge (1.65 mm OD, 1.19 mm ID), 18-gauge, 21-gauge (0.82 mm OD, 0.51 mm ID), 22-gauge (0.72 mm OD, 0.41 mm ID), 23-gauge (0.64 mm OD, 0.33 mm ID), or 24-gauge (0.57 mm OD, 0.31 mm ID). According to some aspects of the present disclosure, the size of the needle may be chosen based on the viscosity and/or components of the composition, or vice versa. According to some aspects of the present disclosure, the size of the needle may be 23-gauge or 25-gauge. In some cases, a larger size of 18-gauge, 20-gauge, 21-gauge, or 22-gauge may be used to inject the compositions disclosed herein. Examples of materials which may be used to form the needle include, but are not limited to, metals and metal alloys, such as stainless steel and Nitinol, and polymers. The distal tip of the needle may be sharpened, and may have a beveled shape. The proximal end of the needle may include a suitable fitting/adaptor (e.g., a Luer adapter) for engagement with a syringe or other reservoir. In some examples, the needle may include an elongated tube or catheter between the needle tip and the proximal fitting/adapter.

As noted above, compositions used with systems disclosed herein may have large particulate matter (relative to the injection system lumen) and/or a high viscosity for passage through a lumen sized to inject the material into the patient. The amount of force required to move the composition through a needle aperture (generally described as “peak load” force) may depend on the viscosity of the composition, the dimensions of the needle (inner diameter, outer diameter, and/or length), and/or the material(s) from which the needle is formed. For example, a greater amount of force may be applied to inject the composition through a 33-gauge needle in comparison to a 7-gauge needle. Additional factors that may affect the amount of force applied to inject the composition may include the dimensions of a catheter (inner diameter, outer diameter, and/or length) connecting the mixing system to the needle. Suitable peak loads for injection with one or two hands may range from about 5 lb·f to about 25 lb·f, such as from about 10 lb·f to about 20 lb·f, e.g., about 15 lb·f. The loads measured for a given gel concentration may vary for different needles and flow rates.

According to some aspects of the present disclosure, a combining device or system can be included in a kit for introducing an injectable material into a patient, whereby the injectable material can include any of a variety of suitable compositions. Kits or systems may be configured to store one or more of the components of a composition until the medical professional is ready to mix the composition for delivery to a patient. For instance, compositions, such as hydrogels, may be prepared so that the precursor(s) and any related activating agent(s) are stored in the kit with diluents as may be needed. Applicators may be used in combination with the same. Kits formed in accordance with various principles of the present disclosure can be manufactured using medically acceptable conditions and contain components that have sterility, purity, and preparation that is pharmaceutically acceptable. Solvents/solutions may be provided in the kit or separately. The kit may include one or more syringes and/or needles for mixing and/or delivery of the injectable material, and/or for additional aspects of the procedure in which the injectable material is to be used. The kit or system may comprise various components as set forth herein. For instance, a target site into which an injectable material is to be delivered may be pre-treated using one or more components of the kit. One example of a pretreatment includes hydrodissection, such as with saline, to create space for injectable material to be injected at or in the vicinity of the target tissue site. Once saline has been injected to the treatment site, a combining device or system can be connected to a needle (e.g., an 18-gauge spinal needle) to then deliver the injectable material to the treatment site. For instance, in treating prostate cancer, a 5-10 mm layer of filler (e.g., gel composition) may be injected along the posterior wall of the prostate between the prostate and rectum. Once the filler has been injected into the space between the rectum and prostate, ultrasound images can be obtained.

In accordance with various principles of the present disclosure, a combining and/or delivery system is configured to facilitate combining of components of an injectable material. In some aspects, the injectable material is a combination of a first component, a second component, and a third component, such as described above. In accordance with various principles of the present disclosure, a combining and/or delivery system includes an adaptor configured to facilitate combining of material in a first injectable material transfer device with a second injectable material transfer device. The first injectable material transfer device defines a chamber containing a component of an injectable material, and the second injectable material transfer device a separate chamber containing a separate component of the injectable material. The adaptor is configured to fluidly couple the first injectable material transfer device and the second injectable material transfer device for combining of the components thereof. The components may be combined within one or both of the chambers of the first and second injectable material transfer devices. In some embodiments, the components are combined to form a precursor, and the combining and/or delivery system has yet another chamber containing an accelerant, an accelerator, an activating agent, a cross-linking inducing agent, a catalyst, an initiator, etc. (such terms may be used interchangeably herein, without intent to limit, reference generally being made to an accelerant for the sake of convenience and without intent to limit). In some embodiments, the first injectable material transfer device has a barrel defining a chamber therein, and a plunger assembly configured to advance towards/into the barrel chamber to eject a material from the barrel chamber and/or to retract away from the barrel chamber to aspirate materials into the barrel chamber. In some embodiments, the other injectable material transfer device is a vial, and the adaptor is a vial adaptor configured to facilitate fluid coupling of the vial with the first injectable material transfer device.

In accordance with various principles of the present disclosure, a multi-chamber combining and/or delivery system formed in accordance with various principles of the present disclosure has a fluid exchange system which provides various pathways, passages, lumens, channels, reservoirs, etc., for fluid communication, exchange, transfer, etc., among various elements, chambers, components, parts, devices, systems, etc., of the multi-chamber combining and/or delivery system. It will be appreciated that reference to communication, exchange, transfer, etc., may be made interchangeably herein without intent to limit unless explicitly indicated. Moreover, terms such as pathways, passages, lumens, channels, reservoirs, etc., may be used interchangeably herein without intent to limit, unless otherwise indicated. Finally, it will be appreciated that references herein to elements, chambers, components, parts, devices, systems, etc., are made without intent to limit unless explicitly indicated.

In some aspects, a combining and/or delivery system formed in accordance with various principles of the present disclosure includes a vial adaptor which defines a part of the fluid exchange system of the multi-chamber combining and/or delivery system. In some aspects, the vial adaptor is configured, at least in part, to fluidly couple a chamber defined in a first injectable material transfer device with the separate chamber defined in the second injectable material transfer device. In accordance with various principles of the present disclosure, the vial adaptor portion of the fluid exchange system includes a fluid exchange lumen as well as a venting lumen. A chamber defined in the first injectable material transfer device may be fluidly coupled with the separate chamber defined in the second injectable material transfer device so that materials may be passed therebetween via the fluid exchange lumen (e.g., transferred, exchanged, etc., between the chambers). As materials are withdrawn from the second injectable material transfer device into the first injectable material transfer device, the venting lumen allows venting of the second injectable material transfer device so that vacuum pressure is not created within the second injectable material transfer device.

In some embodiments, the fluid exchange system includes a piercing element, such as a needle, and a fluid exchange spike. The vial cap includes a stopper configured to retain materials within the chamber defined by the vial. The stopper may have a wall with a thinner portion to facilitate piercing by the piercing element. In accordance with various principles of the present disclosure, the piercing element is configured to pierce through the stopper to facilitate passage of the fluid exchange spike (which is typically wider than the piercing element) through the stopper. The piercing element may define a venting lumen of the fluid exchange system (such as described above), and the fluid exchange spike may define a fluid exchange lumen of the fluid exchange system (such as described above).

In some embodiments, the fluid exchange lumen and the venting lumen of the venting system are defined in spaced apart structures. For instance, in some embodiments. the vial cap defines first and second nozzle ports, defining, respectively, a fluid exchange lumen and a venting lumen of the fluid exchange system. The vial cap nozzle ports are fluidly coupleable with fluid exchange nozzles of a vial adaptor, which, in turn, fluidly couples the vial with another injectable material transfer device.

In some aspects, the first injectable material transfer device has at least one nozzle which may be fluidly coupled with (typically seated with respect to) a nozzle port defined by a vial adaptor. In some aspects, at least the nozzle port (if not also the nozzle) may be considered a component of the fluid exchange system. The nozzle and nozzle port facilitate fluid communication between the chamber defined in the first injectable material transfer device and the vial via the vial adaptor, thereby facilitating exchange of materials via the vial adaptor.

In accordance with various principles of the present disclosure, a vial adaptor is configured to be fluidly coupled with the first and second chambers of a multi-chamber device. In some aspects, the vial adaptor is configured to fluidly couple the first chamber of the multi-chamber device with a separate chamber defined in a separate injectable material transfer device, such as described above. Additionally or alternatively, the vial adaptor includes a purge system including a purge channel and a purge reservoir fluidly communicating with the second chamber of the multi-chamber device. The purge system may be considered to be a part of a fluid exchange system of the vial adaptor, such as a fluid exchange system as described above. Excess/surplus material (e.g., a component of the injectable material to be combined by the combining and/or delivery system) may be purged from the second chamber of the multi-chamber device into the purge reservoir. The amount of excess/surplus material to be purged may be a determined/predetermined amount. For instance, material may be purged from the second based on the amount of material needed for combination with the material within the first chamber. Additionally or alternatively, the purge system may allow purging of air/air bubble from the second chamber to eliminate air in the seal chamber and thereby to prevent injection of air into a patient. In some embodiments, material is purged from the second chamber of the multi-chamber device when material is transferred from the first chamber via the vial adaptor into a third chamber, such as defined by a separate injectable material transfer device. In some embodiments, the fluid exchange system includes a one-way valve seal configured to regulate/limit fluid flow through the second nozzle port of the vial adaptor and/or the second nozzle of the multi-chamber device. In some embodiments, the one-way valve seal is positioned within the vial adaptor.

Various embodiments of combining and/or delivery devices, systems, and methods will now be described with reference to examples illustrated in the accompanying drawings. Reference in this specification to “one embodiment,” “an embodiment,” “some embodiments”, “other embodiments”, etc. indicates that one or more particular features, structures, concepts, and/or characteristics in accordance with principles of the present disclosure may be included in connection with the embodiment. However, such references do not necessarily mean that all embodiments include the particular features, structures, concepts, and/or characteristics, or that an embodiment includes all features, structures, concepts, and/or characteristics. Some embodiments may include one or more such features, structures, concepts, and/or characteristics, in various combinations thereof. It should be understood that one or more of the features, structures, concepts, and/or characteristics described with reference to one embodiment can be combined with one or more of the features, structures, concepts, and/or characteristics of any of the other embodiments provided herein. That is, any of the features, structures, concepts, and/or characteristics described herein can be mixed and matched to create hybrid embodiments, and such hybrid embodiment are within the scope of the present disclosure. Moreover, references to “one embodiment,” “an embodiment,” “some embodiments”, “other embodiments”, etc. in various places in the specification are not necessarily all referring to the same embodiment, nor are separate or alternative embodiments necessarily mutually exclusive of other embodiments. It should further be understood that various features, structures, concepts, and/or characteristics of disclosed embodiments are independent of and separate from one another, and may be used or present individually or in various combinations with one another to create alternative embodiments which are considered part of the present disclosure. Therefore, the present disclosure is not limited to only the embodiments specifically described herein, as it would be too cumbersome to describe all of the numerous possible combinations and subcombinations of features, structures, concepts, and/or characteristics, and the examples of embodiments disclosed herein are not intended as limiting the broader aspects of the present disclosure. It should be appreciated that various dimensions provided herein are examples and one of ordinary skill in the art can readily determine the standard deviations and appropriate ranges of acceptable variations therefrom which are covered by the present disclosure and any claims associated therewith. The following description is of illustrative examples of embodiments only, and is not intended as limiting the broader aspects of the present disclosure.

It will be appreciated that common features in the drawings are identified by common reference characters and, for the sake of brevity and convenience, and without intent to limit, the descriptions of the common features are generally not repeated. For purposes of clarity, not all components having the same reference number are numbered. Moreover, a group of similar elements may be indicated by a number and letter, and reference may be made generally to one or such elements or such elements as a group by the number alone (without including the letters associated with each similar element). Finally, certain features in one embodiment may be used across different embodiments and are not necessarily individually labeled when appearing in different embodiments.

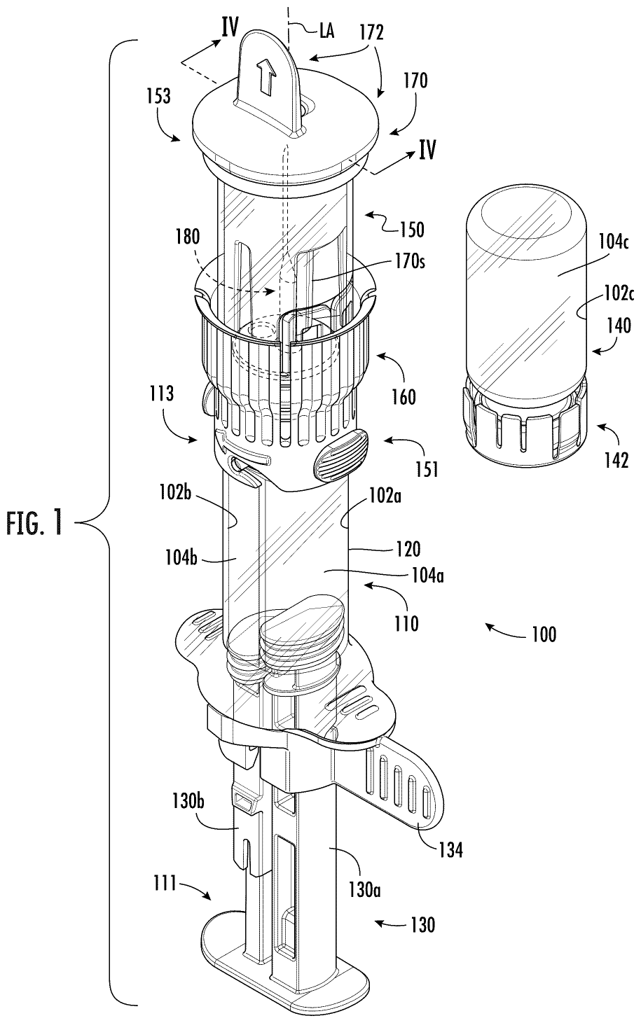

Turning now to the drawings, an example of an embodiment of a combining and/or delivery system 100 formed in accordance with various principles of the present disclosure is illustrated in FIG. 1. The combining and/or delivery system 100 may be used to transport components of an injectable material to a facility/location at which the injectable material is to be delivered (e.g., by injection) into a patient. However, the present disclosure need not be limited to delivery by injection, or even to materials which are specifically injectable. The material combined and/or delivered by a combining and/or delivery system 100 of the present disclosure may be any other type of material to be administered to a patient, such as other than by injection. Thus, it should be appreciated that reference is made herein to combining and/or delivery of injectable materials to be administered to a patient by injection solely for the sake of convenience, and without intent to limit. The injectable material may, as described above, include two or more components which are to remain separate until the time of the procedure. Once a medical professional is ready to inject the injectable material into the patient, the components of the injectable material are combined by the combining and/or delivery system 100 to form (e.g., to react with each other to form) a compound material having the desired characteristics for being delivered to and/or deposited at a target site by the combining and/or delivery system 100.

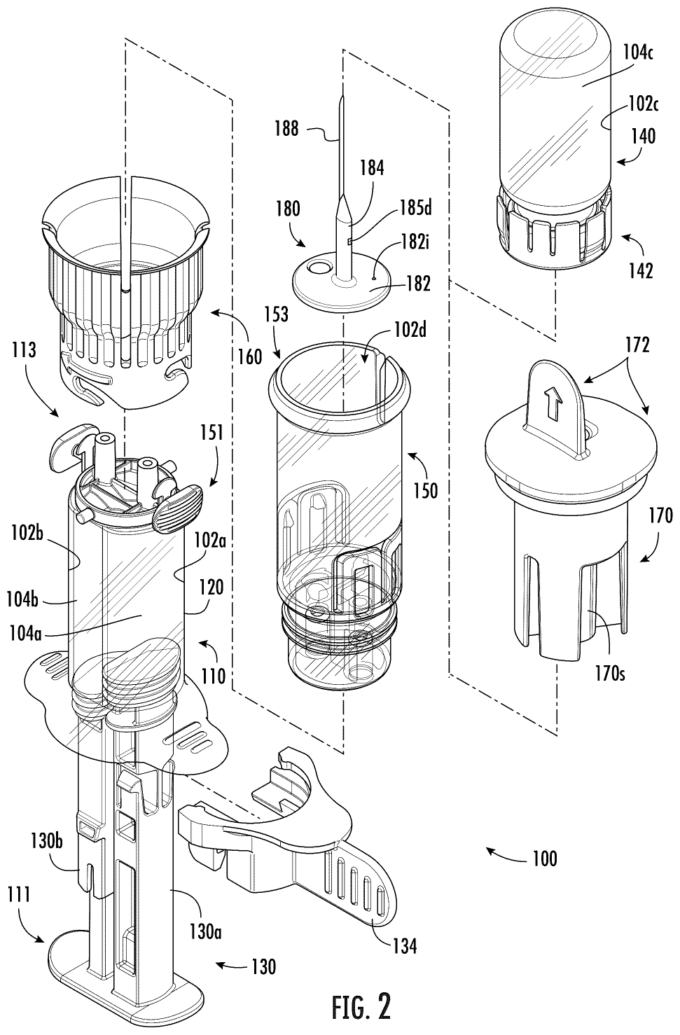

Various elements of the combining and/or delivery system 100 may be appreciated with reference to FIG. 1, and the exploded view thereof illustrated in FIG. 2. The combining and/or delivery system 100 may be considered a multi-chamber combining and/or delivery system 100. The illustrated example of an embodiment of a multi-chamber combining and/or delivery system 100 includes a first injectable material transfer device 110 defining at least one chamber for containing a component of an injectable material to be delivered to a patient. In the example of an embodiment illustrated in FIG. 1 and FIG. 2, the first injectable material transfer device 110 has a barrel 120 and a plunger assembly 130. The barrel 120 defines a first chamber 102a and a second chamber 102b, and the plunger assembly 130 has a first plunger rod 130a slidable within the first barrel chamber 102a, and a second plunger rod 130b slidable within the second barrel chamber 102b. The plunger assembly 130 extends proximally from the barrel 120 (towards the proximal end 111 of the first injectable material transfer device 110), and is movable, such as axially/longitudinally slidable (e.g., along the longitudinal axis LA), with respect to the barrel 120 to move (e.g., eject) materials out of and/or to move (e.g., aspirate) materials into chambers within the barrel 120 upon movement of the respective plunger rods 130a, 130b thereof within the barrel 120.

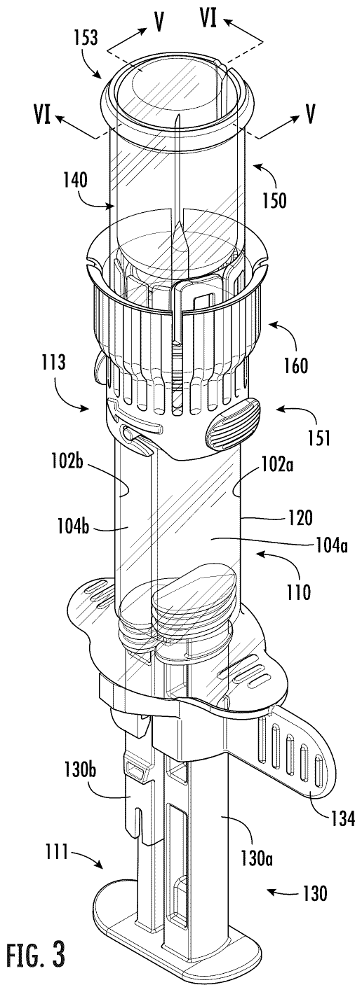

The example of an embodiment of a multi-chamber combining and/or delivery system 100 illustrated in FIG. 1 and FIG. 2 further includes a separate chamber 102c. The separate chamber 102c is defined in a separate device 140, formed and provided separately from the first injectable material transfer device 110, such as illustrated in FIG. 1 and FIG. 2. For the sake of convenience, and without intent to limit, the separate device is referenced herein as a vial 140, and the separate chamber 102c is referenced as a third chamber 102c (which may alternately be referenced herein as a vial chamber 102c) defined by a vial body 142. In accordance with various principles of the present disclosure, the third chamber 102c of the vial 140 is to be fluidly coupled with one of the chambers 102a, 102b of the first injectable material transfer device 110 to combine the contents thereof, such as illustrated in FIG. 3.

In the illustrated example of an embodiment, the first chamber 102a of the first injectable material transfer device 110 is configured to contain a first component 104a, the second chamber 102b of the first injectable material transfer device 110 is configured to contain a second component 104b, and the third chamber 102c of the first injectable material transfer device 110 is configured to contain a third component 104c. The first component 104a, the second component 104b; and the third component 104c are to be combined to form an injectable material to be delivered to a patient. In some aspects, the first chamber 102a, the second chamber 102, and the third chamber 102c are defined to be separate and fluidly-isolated from one another. For instance, the first component 104a, may react with the second component 104b, when combined. In some embodiments, the first component 104a is combined with the third component 104c, either within the first chamber 102a and/or within the third chamber 102c, as described in further detail below, such as to form a precursor 104d, which is to be contained in the first chamber 102a. The second component 104b may react with the precursor 104d if and when combined therewith (e.g., to accelerate reaction of the first component 104a and the third component 104c). Therefore, it may be desirable to keep the second component 104b separate from the precursor 104d until ready for delivery to a patient. Fluid isolation of the chambers 102a, 102b of the first injectable material transfer device 110 prevents unintentional and/or premature combination of the contents of the first chamber 102a (the first component 104a, or the precursor 104d formed by combining the first component 104a and the third component 104c) with the contents of the second chamber 102b (the second component 104b). When (e.g., only when) a medical professional is ready to administer the injectable material (e.g., as a combined injectable material), the components within the chambers 102a, 102b are combined and allowed to react with each other. Various devices, systems, and method of the present disclosure facilitate case and accuracy of combination of such components at the appropriate time, such as described in further detail below.

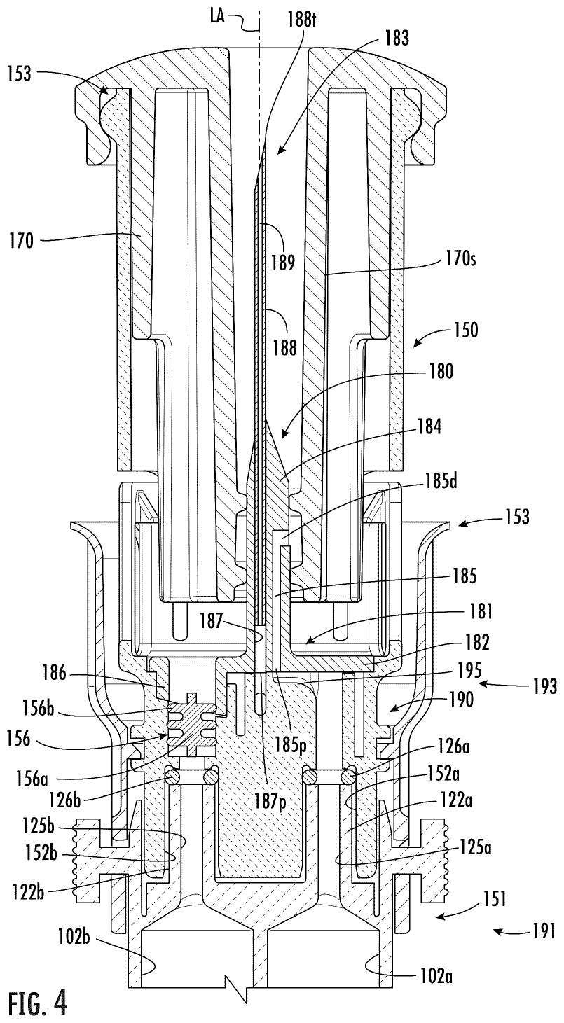

In accordance with various principles of the present disclosure, the combining and/or delivery system 100 further includes a vial adaptor 150 configured to facilitate fluid communication between the first chamber 102a and the third chamber 102c of the combining and/or delivery system 100. The example of an embodiment of a vial adaptor 150 illustrated in FIG. 1 has a proximal end 151 defining a first nozzle port 152a and a second nozzle port 152b configured to be fluidly coupled with the first injectable material transfer device 110, such as illustrated in FIG. 4, showing a cross-sectional along line IV-IV of FIG. 1. A vial adaptor wall 154 defines a fourth chamber 102d of the combining and/or delivery system 100 opening to the distal end 153 of the vial adaptor 150. The fourth chamber 102d is configured to facilitate coupling of the first injectable material transfer device 110 with an additional injectable material transfer device. For instance, the fourth chamber 102d may be configured as a vial-receiving chamber configured to receive a vial 140, and to hold the vial 140 with respect to the first injectable material transfer device 110, as illustrated, for example, in FIG. 3. The vial adaptor 150 may further be configured to facilitate holding and/or coupling and/or alignment of the vial 140 with respect to the first injectable material transfer device 110 to establish fluid communication between the first chamber 102a and the third chamber 102c to exchange materials therebetween. For instance, the vial adaptor 150 may facilitate alignment and/or fluid sealing between the first injectable material transfer device 110, the vial adaptor 150, and the vial 140 so that materials may be transferred between the vial 140 (when positioned within the vial adaptor 150) and the first injectable material transfer device 110 without leakage, and/or without significant manipulation of components of the combining and/or delivery system 100, such as in a manner described in further detail below. More particularly, the vial adaptor 250 facilitates fluid coupling of a first chamber 202a of a multi-chamber device 210 formed in accordance with various principles of the present disclosure with a separate chamber 202c, and the combination of the components 204a, 204c contained within the chambers 202a, 202c.

In the example of an embodiment of a combining and/or delivery system 100 illustrated in FIG. 1 and FIG. 2, a sleeve lock 160 facilitates secure coupling of the vial adaptor 150 with the first injectable material transfer device 110. For instance, the example of an embodiment of a sleeve lock 160 illustrated in FIG. 1 and FIG. 2 is configured to stabilize the first injectable material transfer device 110 and the vial adaptor 150 with respect to each other, such as to maintain fluid coupling therebetween without leakage. For instance, the sleeve lock 160 may be generally cylindrical, such as in the shape of a ring or collar, and may alternately be referenced as a locking ring, locking collar, adaptor ring, adaptor collar, etc., without intent to limit. The length of the sleeve lock 160 along the longitudinal axis LA of the first injectable material transfer device 110 may be selected to hold the vial adaptor 150 against lateral movement (transverse to the longitudinal axis LA) with respect to the first injectable material transfer device 110 when coupled thereto. Further details of a sleeve lock 160 such as illustrated in FIG. 1-FIG. 6 may be appreciated with reference to co-pending provisional patent application, titled DEVICES, SYSTEMS, AND METHODS FOR COMBINING AND/OR DELIVERING INJECTABLE MATERIALS, and filed on even date herewith [ATTORNEY DOCKET 2001.3126100] which application is hereby incorporated by reference herein in its entirety and for all purposes.

As illustrated in FIG. 1, a protective cap 170 may be positioned within the fourth chamber 102d of the vial adaptor 150 before the vial 140 is positioned within the fourth chamber 102d (illustrated in FIG. 3). The protective cap 170 may be configured to protect or shield components of a fluid exchange device 180 provided along the distal end 153 of the vial adaptor 150. The protective cap 170 extends inwardly within the fourth chamber 102d defined by the vial adaptor 150 toward the proximal end 181 of the fluid exchange device 180, as may be appreciated with reference to the cross-sectional view of FIG. 4, taken along line IV-IV in FIG. 1. Although the protective cap 170 may not necessarily fully cover the proximal end 181 of the fluid exchange device 180, the protective cap 170 optionally includes a shield portion 170s configured to extend around at least the distal end 183 of the fluid exchange device 180, as may also be appreciated with reference to FIG. 4. Additionally or alternatively, the protective cap 170 may protect the vial adaptor 150 from entry of unwanted matter or debris from entering the fourth chamber 102d.

To prepare the first injectable material transfer device 110 for combining the first component 104a contained within the first chamber 102a with the third component 104c contained within the third chamber 102c (such as defined within the vial 140), the protective cap 170 is separated from the vial adaptor 150 (e.g., removed from the fourth chamber 102d). The vial 140 may then be positioned within the fourth chamber 102d (defined by the vial adaptor 150), as illustrated in FIG. 3. The first chamber 102a (defined the first injectable material transfer device 110) and the third chamber 102c (defined in the vial 140) may thereby be fluidly coupled via the vial adaptor 150, as described in further detail below. Optionally, the protective cap 170 includes a grasping section 172, such as a radially-outwardly projecting flange and/or an axially extending projection/wing, configured to facilitate grasping and/or pulling on the protective cap 170 to remove the protective cap 170 from the vial-receiving fourth chamber 102d of the multi-chamber combining and/or delivery system 100 defined in the vial adaptor 150.

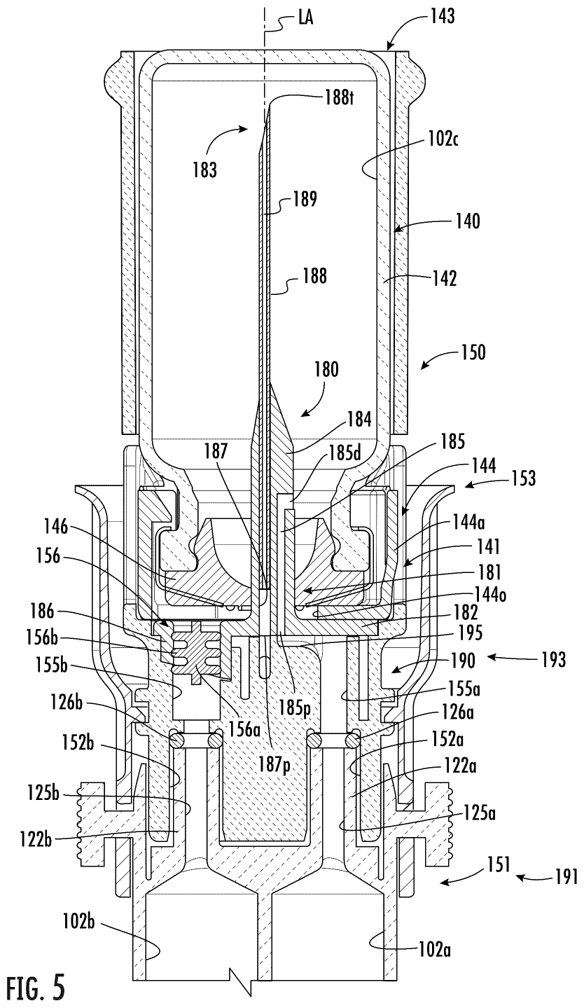

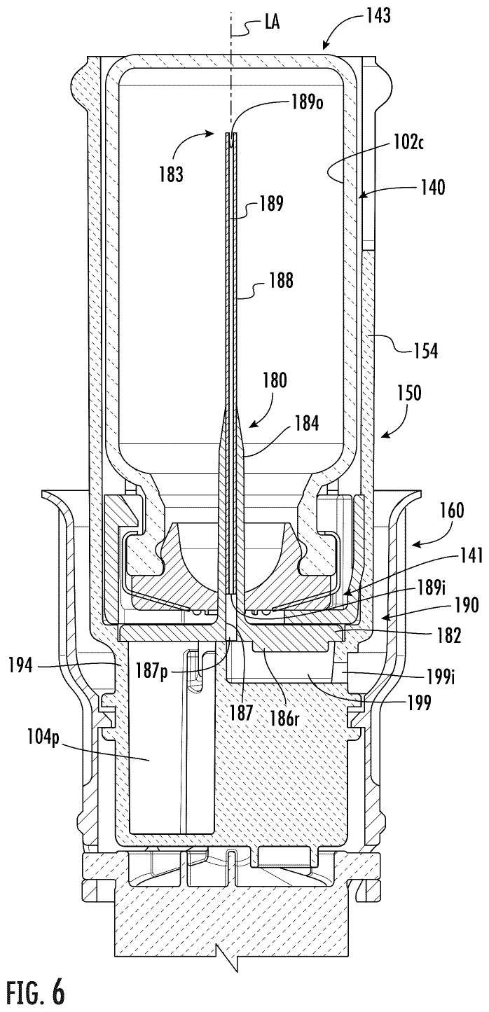

In accordance with various principles of the present disclosure, a vial adaptor 150 such as illustrated in FIGS. 1-6 provides various fluid exchange pathways, passages, lumens, channels, reservoirs, etc., facilitating fluid communication and/or fluid exchange between a first chamber 102a and at least a third chamber 102c (such as positioned within the fourth chamber 102d defined by the vial adaptor 150) of a multi-chamber combining and/or delivery system 100 formed in accordance with various principles of the present disclosure. For instance, as may be appreciated with reference to FIG. 5, showing a cross-sectional view along line V-V in FIG. 3, and the perspective view of FIG. 7, the vial adaptor 150 defines various lumens for fluid communication between the illustrated first chamber 102a and third chamber 102c, such as to allow further fluid exchange therebetween, as described in further detail below. Additionally or alternatively, as may be appreciated with reference to FIG. 6, showing a cross-sectional view along line VI-VI in FIG. 3, and the perspective view of FIG. 7, the vial adaptor 150 defines a venting lumen for the third chamber 102c, such as to reduce and/or eliminate potential vacuum pressure as material is withdrawn from the third chamber 102c, as described in further detail below. Additionally or alternatively, as may be appreciated with reference to FIG. 5, showing a cross-sectional view along line V-V in FIG. 3, and the perspective view of FIG. 7, the vial adaptor 150 provides optional purging of the second chamber 102b, as described in further detail below. It is noted that in the illustrated examples of embodiments, the third chamber 102c is positioned within a fourth chamber 102d, and, as such, the first chamber 102a may be considered to be generally fluidly coupled with the fourth chamber 102d as well. Moreover, it will be appreciated that the illustrated vial 140 may be replaced with other additional devices separate from the first injectable material transfer device 110, receivable by the vial adaptor 150, and defining yet another chamber therein. Such additional chambered devices may be in any configuration such as known to those of ordinary skill in the art (such as, yet not limited to, a vial such as the vial 140 illustrated in FIG. 3, FIG. 5, and FIG. 6), illustration thereof being unnecessary for a full and complete understanding thereof by of ordinary skill in the art. Accordingly, descriptions of fluid communications of the first chamber 102a with another chamber (e.g., the third chamber 102c) may be applicable to the fourth chamber 102d and/or additional chambers positioned or provided within the fourth chamber 102d.

Returning to FIG. 5 and FIG. 7, the illustrated example of an embodiment of a vial adaptor 150 is configured to be coupled with the illustrated example of an embodiment of a first injectable material transfer device 110 to fluidly communicate the chamber 102a, 102d defined within the barrel 120 of the first injectable material transfer device 110 with the fourth chamber 102d defined by the vial adaptor 150. It will be appreciated that such fluid coupling also allows the vial adaptor 150 to fluidly communicate the chambers 102a, 102b defined within the barrel 120 of the first injectable material transfer device 110 with additional chambers fluidly coupled with the vial adaptor 150. For instance, the vial adaptor 150 facilitates fluid coupling of the first chamber 102a with the third chamber 102c defined within the vial 140 when the vial 140 is positioned within the fourth chamber 102d, such as illustrated in FIG. 3 and FIG. 5.

In the example of an embodiment illustrated in cross-section in FIG. 4 and FIG. 5, fluid coupling of the first injectable material transfer device 110 and the vial adaptor 150 is achieved via nozzles 122a, 122b of the barrel 120 of the first injectable material transfer device 110 (such as illustrated in FIG. 2) and nozzle ports 152a, 152b of the vial adaptor 150. More particularly, the illustrated example of an embodiment of a vial adaptor 150 defines, at its proximal end 151, a first nozzle port 152a and a second nozzle port 152b positioned and configured to be fluidly coupled with, respectively, a first barrel nozzle 122a and a second barrel nozzle 122b extending distally from the distal end 123 of the barrel 120. Specifically, the vial adaptor nozzle ports 152a, 152b may be configured to receive and to be in fluid communication with the barrel nozzles 122a, 122b, and/or the barrel nozzles 122a, 122b may be configured to be seated with respect to, such as by being inserted into (e.g., to extend within) the vial adaptor nozzle ports 152a, 152b to be fluidly coupled therewith. The chambers 102a, 102b within the barrel 120 may thereby be fluidly communicated with the fourth chamber 102d defined by the vial adaptor 150 and/or an additional chamber positioned within the fourth chamber 102d (e.g., a third chamber 102c within a vial 140) via lumens 125a, 125b which are respectively defined through the barrel nozzles 122a, 122b, fluid passages defined by the nozzle ports 152a, 152b, and fluid exchange lumens 155a, 155b defined in the vial adaptor 150, and the fluid exchange device 180. Seals 126a, 126b (e.g., O-rings) may be provided, respectively, between the barrel nozzles 122a, 122b and the vial adaptor nozzle ports 152a, 152b, such as to seal against leakage, such as in a manner such as known to those of ordinary skill in the art.

Once the vial 140 is positioned within the fourth chamber 102d defined by the vial adaptor 150, as illustrated in FIG. 3, the fluid exchange device 180 may fluidly communicate the first chamber 102a (defined with the barrel 120) with the third chamber 102c (defined within the vial 140), as illustrated in FIG. 5. It will be appreciated that the fluid exchange device 180 may be considered to be part of an overall fluid exchange system of the combining and/or delivery system 100 which may be considered to include elements/components of the first injectable material transfer device 110, the vial adaptor 150, and even the vial 140 which are configured and engaged to facilitate fluid communication and exchange among the various chambers of the multi-chamber combining and/or delivery system 100. In accordance with various principles of the present disclosure, the fluid exchange device 180 is positioned and configured with respect to a multi-chamber combining and/or delivery system 100 formed in accordance with various principles of the present disclosure to provide fluid communication between at least a first chamber 102a (via the first vial adaptor nozzle port 152a and the first barrel nozzle 122a) and a fourth chamber 102d (defined within a vial adaptor 150). Furthermore, in accordance with various principles of the present disclosure, the fluid exchange device 180 is positioned and configured with respect to the multi-chamber combining and/or delivery system 100 to provide fluid communication between at least the first chamber 102a and a third chamber 102c defined within a vial 140 positioned within the fourth chamber 102d defined by the vial adaptor 150.

More particularly, as may be appreciated with reference to FIG. 5, the fluid exchange device 180 includes a base portion 182 from which a fluid exchange spike 184 extends. The fluid exchange spike 184 configured to fluidly communicate at least a first chamber 102a and a third chamber 102c of a multi-chamber combining and/or delivery system 100 formed in accordance with various principles of the present disclosure. The fluid exchange spike 184 may be formed integrally with (e.g., as a single piece with) or separately from the fluid exchange device base portion 182. As illustrated in FIG. 5, the fluid exchange spike 184 has a fluid exchange lumen 185 extending therethrough with a distal end 185d extending through the fluid exchange spike 184 to be positioned within the chamber 102c (as defined within the illustrated vial 140), and a proximal end 185p extending through a base portion 182 of the fluid exchange device 180. As further illustrated in FIG. 5, the proximal end 185p of the fluid exchange lumen 185 is in fluid communication with the first chamber 102a (defined within the first injectable material transfer device 110) of the multi-chamber combining and/or delivery system 100 via the first vial adaptor exchange lumen 155a defined in the vial adaptor 150, in a manner as detailed above. The fluid exchange lumen 185 thereby fluidly communicates the third chamber 102c of the multi-chamber combining and/or delivery system 100 with the first chamber 102a of the multi-chamber combining and/or delivery system 100. A first component 104a within the first chamber 102a may thereby be transferred from the first chamber 102a to the third chamber 102c, and combined, within the third chamber 102c, with a third component 104c within the third chamber 102c. The combined first component 104a and second component 104b (which may be considered a precursor 104d) may then be transferred from the third chamber 102c to the first chamber 102a (e.g., aspirated into the first chamber 102a) for delivery to a patient.

As noted above, the vial adaptor 150 may provide various fluid exchange pathways, passages, lumens, channels, etc., facilitating fluid communication and/or fluid transfer between the first chamber 102a and at least the third chamber 102c of the multi-chamber combining and/or delivery system 100. More particularly, the example of an embodiment of a vial adaptor 150 illustrated in FIG. 1-FIG. 7 has a vial adaptor base portion 190 defining various fluid exchange pathways, passages, lumens, channels, reservoirs, etc., such as may be appreciated with reference to the perspective view of FIG. 7. The vial adaptor base 190 may be formed integrally with (e.g., as a single piece with) or separately from the portion of the vial adaptor 150 defining the above-described fourth chamber 102d. As may be appreciated with reference to FIG. 7, the illustrated example of an embodiment of a vial adaptor base portion 190 has a fluid exchange channel 192 defined along a distal side 193 of the vial adaptor base portion 190. As illustrated in FIG. 5, the fluid exchange device base portion 182 cooperates with the vial adaptor base portion 190 to form a base fluid exchange lumen 195 defined by the fluid exchange device base portion 182 and the fluid exchange channel 192. As may be appreciated with reference to FIG. 5 and FIG. 7, the base fluid exchange lumen 195 is in fluid communication with the first vial adaptor exchange lumen 155a and the first vial adaptor nozzle port 152a (defined in/by a proximal side 191 of the vial adaptor base portion 190).

It is noted that the distal side 193 of the vial adaptor base portion 190 may also define, with the side wall 194 of the vial adaptor base portion 190, a purge reservoir 104p. The purge reservoir may be considered a fifth chamber of the multi-chamber combining and/or delivery system 100. The vial adaptor base portion 190 fluidly communicates such fifth chamber (defined in the distal side 193 of the vial adaptor base portion 190) with the second chamber 102b via the second vial adaptor exchange lumen 155b and the second vial adaptor nozzle port 152b (defined in/by the proximal side 191 the vial adaptor base portion 190), and the second nozzle port 152b of the second barrel nozzle 122b. The purge reservoir 104p is described in further detail below with reference to fluid communication provided by the vial adaptor 150 with respect to the second chamber 102b to purge the second chamber 102b.

The above-described fluid exchange device base portion 182 may be sealed with respect to the vial adaptor base portion 190 to seal the base fluid exchange lumen 195, such as to assure passage of materials between the first chamber 102a and the third chamber 102c of the multi-chamber combining and/or delivery system 100 without leakage. It will be appreciated that fluid exchange device base portion 182 may be formed integrally with the fluid exchange spike 184 such that no sealing is required with respect to the fluid exchange spike 184 and the fluid exchange device base portion 182. Moreover, it will be appreciated that the base fluid exchange lumen 195 and the first vial adaptor exchange lumen 155a may be sealed with respect to the first barrel nozzle lumen 125a by the first scal 126a. In some embodiments, the fluid exchange device base portion 182 has a cross-sectional shape generally corresponding with the cross-sectional shape of the vial adaptor base portion 190 (e.g., circular, as shown in FIG. 7) and the fluid exchange device basc portion 182 may be scaled with respect to the vial adaptor base portion 190 to seal/fluidly isolate the various passages within the vial adaptor base portion 190 from one another. However, if desired, other sealing elements, such as known to those of ordinary skill in the art, may be used, in addition to or instead of matching cross-sectional shapes, to achieve such scaling.

In some embodiments, the fluid exchange device base portion 182 includes a proximal extension 186 configured to extend into the second vial adaptor exchange lumen 155b, such as may be appreciated with reference to FIG. 2b, FIG. 4, and FIG. 5. Additionally or alternatively, the fluid exchange device base portion 182 includes an alignment rib 186r extending generally radially along the proximal surface of the fluid exchange device base portion 182, and positioned, sized, shaped, configured, and/or dimensioned to extend proximally into the venting channel 198 in the vial adaptor base portion 190 (and at least partially defining a base venting lumen 199, as discussed in further detail below), such as may be appreciated with reference to FIG. 6 and FIG. 7. The fluid exchange device proximal extension 186 and/or the alignment rib 186r may contribute to maintaining the position of the fluid exchange device base portion 182 with respect to the vial adaptor base portion 190, such as to maintain alignment of various features thereof. For instance, the proximal extension 186 and at least the second vial adaptor exchange lumen 155b may have noncircular cross-sections (e.g., oval, square, rectangular, oblong, etc.) to inhibit relative rotation therebetween. In the example of an embodiment illustrated in FIG. 4, FIG. 5, FIG. 6, and FIG. 7, the fluid exchange device proximal extension 186 and/or the alignment rib 186r may maintain alignment of the proximal end 185p of the fluid exchange lumen 185 of the fluid exchange device 180 (which may be offset from the longitudinal axis LA of the multi-chamber combining and/or delivery system 100) with the fluid exchange channel 192 defined in the vial adaptor base portion 190 to maintain fluid communication therebetween.

In view of the above, it will be appreciated that the base fluid exchange lumen 195 is at least fluidly isolated from/sealed with respect to the second vial adaptor exchange lumen 155b, the second vial adaptor nozzle port 152b, and the second barrel nozzle lumen 125b to prevent combining of the second component 104b (within the second chamber 102b and in fluid communication with the second barrel nozzle lumen 125b) with any of the first component 104a (within the first chamber 102a), the third component 104c (within the third chamber 102c), or the precursor 104d (formed by combining the first component 104a and the third component 104c). At the appropriate time, the precursor 104d may be combined with the second component 104b contained in the second chamber 102b, such as described above. However, such combination is typically performed once the components 104a/104d and 104b have been ejected from their respective chambers 102a, 102b. For instance, the combining of the components 104a/104d and 104b may occur within another device (e.g., an injection system) and/or within the patient, such as in a manner described in co-pending provisional patent application ______, titled DEVICES, SYSTEMS, AND METHODS FOR COMBINING AND/OR DELIVERING INJECTABLE MATERIALS, and filed on even date herewith [ATTORNEY DOCKET 2001.3125100] which application is hereby incorporated by reference herein in its entirety and for all purposes.

In embodiments in which the second component 104b is to be maintained separate from the first component 104a and/or the precursor 104d, in addition to the above-described scaling of various passages within the vial adaptor 150, a valve seal 156 may be positioned in the second vial adaptor exchange lumen 155b. The valve seal 156 is positioned, sized, shaped, configured, and/or dimensioned to prevent unwanted flow of materials with respect to the second chamber 102b (within the first injectable material transfer device 110) via the second vial adaptor nozzle port 152b and the second barrel nozzle lumen 125b. As such, the valve seal 156 may ensure the correct components within the multi-chamber combining and/or delivery system 100 are mixed with one another and/or may minimize if not eliminate mixing errors. Further aspects of the valve seal 156 are described in further detail below.

In accordance with various principles of the present disclosure, a fluid exchange device 180 associated with a vial adaptor 150 formed in accordance with various principles of the present disclosure may further include a distal extension 188 extending distally from the fluid exchange spike 184, such as illustrated in FIG. 2. The fluid exchange device distal extension 188 may be mounted with respect to (e.g., on or in) the fluid exchange spike 184. For instance, in the example of an embodiment illustrated in the cross-sectional views of FIG. 4, FIG. 5, and FIG. 6, the fluid exchange spike 184 includes a support lumen 187 configured to support the fluid exchange device distal extension 188. However, other manners of mounting and/or coupling a fluid exchange spike 184 and fluid exchange device distal extension 188 known to those of ordinary skill in the art are within the scope and spirit of the present disclosure, the present disclosure not being limited in this regard. For instance, it will be appreciated that, instead of being formed as separate components, the fluid exchange device distal extension 188 may be formed integrally with (e.g., as a single piece with) the fluid exchange spike 184. In the fluid exchange device 180 illustrated in FIG. 4 and FIG. 5, the support lumen 187 and the fluid exchange lumen 185 are separate and spaced apart from each other. One or both of the support lumen 187 and the fluid exchange lumen 185 may be generally axially-extending (along the longitudinal axis LA) and/or parallel to each other.

In the example of an embodiment illustrated in FIG. 2, FIG. 4, and FIG. 5, the fluid exchange device distal extension 188 is configured as a piercing element, such as a needle. The fluid exchange device distal extension 188 may end at a sharpened distal tip 188t at the distal end 183 of the fluid exchange device 180, and therefore is covered by the protective cap 170 before the vial 140 is positioned within the vial-receiving fourth chamber 102d of the vial adaptor 150, as described above with reference to FIG. 1, and as illustrated in further detail in the cross-sectional view in FIG. 4. In some embodiments, the sharpened distal tip 188t is configured to facilitate passage of the fluid exchange spike 184 into a third chamber 102c defined within a vial 140 fluidly coupled with the vial adaptor 150. For instance, in some embodiments, the vial 140 has a vial cap 144 closing the open proximal end 141 of the vial body 142 (to contain the third component 104c within the third chamber 102c defined therein). The vial cap 144 has a generally central open region 1440 allowing access to a plug or stopper 146 positioned within the open proximal end 141 of the vial body 142, as may be appreciated with reference to FIG. 5. The sharpened distal tip 188t of the fluid exchange device distal extension 188 may be positioned, sized, shaped, configured, and/or dimensioned to pierce through the vial stopper 146 to extend into the third chamber 102c defined within the vial 140. It will be appreciated that terms such as pierce, puncture, etc., (including other grammatical forms thereof) may be used interchangeably herein without intent to limit unless otherwise specified. Once the stopper 146 has been pierced, the wider fluid exchange spike 184 (generally having a larger cross-sectional area than that of the fluid exchange device distal extension 188 extending distally therefrom) may more readily extend through the stopper 146 of the vial 140.

In some embodiments, the vial stopper 146 may be formed of a suitable material known to those of ordinary skill in the art as capable of sealing the third component 104c within the third chamber 102c defined within the vial 140 (e.g., an clastic material). The material of the stopper 146 optionally also allows the sharpened distal tip 188t of the fluid exchange device distal extension 188 to pierce through the stopper 146 to extend into the third chamber 102c. In some embodiments, the stopper 146 has a reduced wall thickness (e.g., a thinner wall portion, such as illustrated in FIG. 5) for facilitating piercing thereof by the sharpened distal tip 188t. It will be appreciated that the sharpened distal tip 188t may be positioned to be generally aligned with a thinner wall portion of the stopper 146 (e.g., aligned with a thinner wall portion along a generally central region of the stopper 146) to facilitate piercing of the thinner wall portion of the stopper 146 by the sharpened distal tip 188t.

As noted above, it may be desirable to vent the third chamber 102c as materials are withdrawn/aspirated therefrom. In accordance with various principles of the present disclosure, and as noted above, the example of an embodiment of a vial adaptor 150 illustrated in FIG. 1-FIG. 7 provides venting of the third chamber 102c as the contents thereof (e.g., the third component 104c delivered therein, or a precursor 104d formed therein if the first component 104a is injected into the third chamber 102c to be combined with the third component 104c delivered therein) are withdrawn/aspirated. For instance, as illustrated in the cross-sectional view in FIG. 6, a fluid exchange device venting lumen 189 may be defined through the fluid exchange device distal extension 188. The illustrated example of an embodiment of a fluid exchange device venting lumen 189 has an outlet 1890 extending into the third chamber 102c distal to the distal end 185d of the fluid exchange lumen 185 (i.e., further into the third chamber 102c and closer to the distal end 143 of the vial 140 than the distal end 185d of the fluid exchange lumen 185 extends) such as to assure communication with empty space within the vial 140 (e.g., when the vial 140 is inverted, as illustrated in FIG. 6), rather than with the third component 104c within the vial 140. The fluid exchange device venting lumen 189 extends from an outlet 1890 thereof at the distal tip 188t of the fluid exchange device distal extension 188 proximally to an inlet 189i thereof. The fluid exchange device venting lumen inlet 189i is communicated with atmospheric pressure via the base venting lumen 199. The base venting lumen 199 communicates with atmospheric pressure via a venting lumen inlet 199i defined in the side wall 194 of the vial adaptor base portion 190 to equalize pressure within the third chamber 102c as material is withdrawn/aspirated therefrom.

In some aspects, fluid exchange device distal extension 188 defines the fluid exchange device venting lumen 189 with the support lumen 187 in the fluid exchange spike 184. For instance, the fluid exchange device venting lumen 189 may be coextensive with the support lumen 187. As may be appreciated with reference to FIG. 6, the fluid exchange device venting lumen inlet 189i fluidly communicates with the support lumen 187, and the proximal end 187p of the support lumen 187 extends through the base portion 182 of the fluid exchange device 180 and into fluid communication with the base venting lumen 199.

As may be appreciated with reference to FIG. 6 and FIG. 7, one of the above-noted various fluid exchange pathways, passages, lumens, channels, reservoirs, etc., of the illustrated example of an embodiment of a vial adaptor base portion 190 may include a venting channel 198 which cooperates with the fluid exchange device base portion 182 to define the base venting lumen 199. The base venting lumen 199 may be sealed/fluidly isolated from fluid communication with other pathways, passages, lumens, channels, reservoirs, etc., within the multi-chamber combining and/or delivery system 100 by the above described sealing of the fluid exchange device base portion 182 with respect to the vial adaptor base portion 190, such as described above Moreover, the various alignment features described above with reference to alignment of the fluid exchange device base portion 182 with respect to the vial adaptor base portion 190 may also align the proximal end 187p of the support lumen 187 with the venting channel 198 defined in the vial adaptor base portion 190 to maintain fluid communication therebetween.

As noted above, in some embodiments it may be desirable to purge some material from the second chamber 102b. For instance, it may be desirable purge any remaining air (e.g., air bubbles) within the second chamber 102b so that air in not injected into the patient when injecting the second component 104b into the patient. In accordance with various principles of the present disclosure, the fluid exchange system of the example of an embodiment of a multi-chamber combining and/or delivery system 100 defines a purge system. The purge system includes the above-described purge reservoir 104p defined in the proximal side 193 of the vial adaptor base portion 190. At least a portion of the second vial adaptor exchange lumen 155b may extend through a seal chamber 196 defined on the distal side 193 of the vial adaptor base portion 190 for a valve seal 156 to be positioned therein. The second vial adaptor exchange lumen 155b (or at least a portion thereof) may thus be considered (and alternately referenced herein as) a valve lumen 155b. In some embodiments, the above-described fluid exchange device proximal extension 186 extends proximally into the valve lumen 155b in a manner allowing the valve seal 156 to shift (e.g., axially along the longitudinal axis LA) within the fluid exchange device proximal extension 186 as well as the second vial adaptor exchange lumen 155b, such as illustrated in FIG. 5. Excess/surplus material may be purged out from the second chamber 102b to flow into the valve lumen 155b (via the second barrel nozzle lumen 125b and the second vial adaptor nozzle port 152b), and past the valve seal 156, and through the purge channels 197 defined in the wall of the seal chamber 196 (as illustrated in FIG. 7), and into the purge reservoir 104p.

More particularly, to purge the second chamber 102b, the second plunger rod 130b may be extended distally into the second chamber 102b to eject excess/surplus material and/or air therefrom, through the second barrel nozzle lumen 125b and into the second vial adaptor exchange lumen 155b (via the second vial adaptor nozzle port 152b). In some aspects, the second plunger rod 130b is advanced at the same time the first plunger rod 130a is advanced to eject material from the first chamber 102a into the third chamber 102c. The valve seal 156 may be sized, shaped, configured, and/or dimensioned such that the ejected material may distally move the valve seal 156 in the seal chamber 196 (e.g., from a sealing position as illustrated in FIG. 4 to a purge position as illustrated in FIG. 5) to flow past the valve seal 156 and through the purge channels 197 defined in the wall of the seal chamber 196 and into the purge reservoir 104p. As such, any second component 104b purged from the second chamber 102b is collected within the multi-chamber combining and/or delivery system 100 and not expelled outside the system 100 (e.g., onto the medical professional, the patient, the floor, etc.). In some embodiments, a vent hole 182i is defined in the fluid exchange device base portion 182 (such as illustrated in FIG. 2), such as to vent the purge reservoir 104p in a manner known to those of ordinary skill in the art.

The valve seal 156 may thereby regulate flow of the second component 104b out from the second chamber 102b and into the purge reservoir 104p. In some embodiments, the valve seal 156 may be a one-way valve positioned, sized, shaped, configured, and/or dimensioned to allow purging of materials out of the second chamber 102b as needed/desired, yet to prevent undesired flow of materials into the second chamber 102b. For instance, the valve seal 156 may prevent materials ejected out of the first chamber 102a and/or aspirated out of the third chamber 102c from flowing into (e.g., being aspirating into) the second chamber 102b. Alternative configurations of the valve seal 156 are described in further detail below.

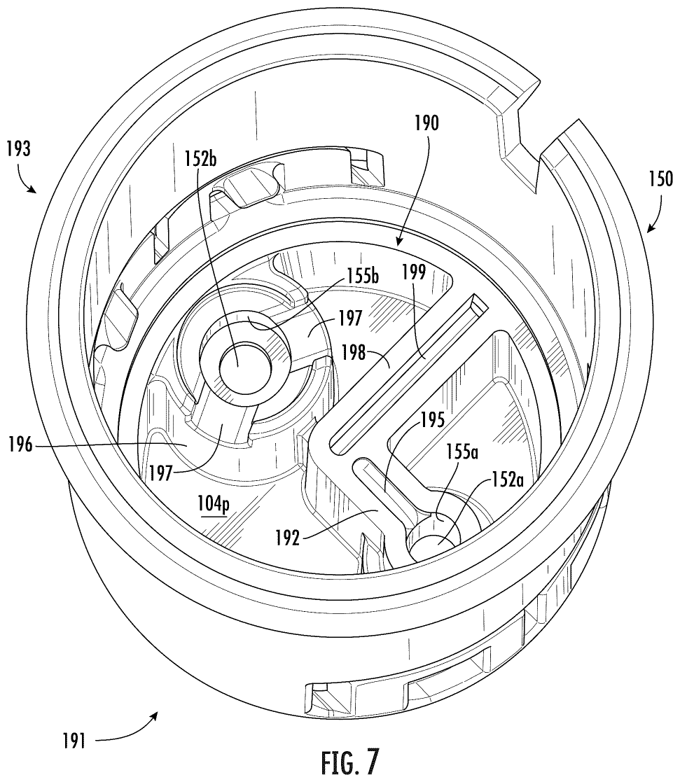

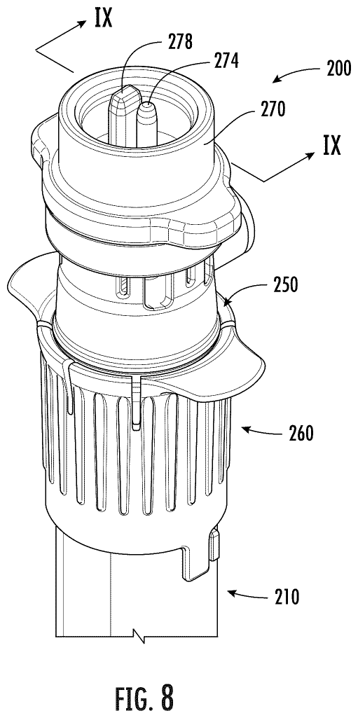

It will be appreciated that various principles of the present disclosure may be applied in alternate forms and configurations without departing from the scope and spirit of the present disclosure. An alternate example of an embodiment of a multi-chamber combining and/or delivery system 200 formed in accordance with various principles of the present disclosure is illustrated in FIG. 8-FIG. 12. Like the above-described multi-chamber combining and/or delivery system 100 illustrated in FIG. 1-FIG. 7, the multi-chamber combining and/or delivery system 200 illustrated in FIG. 8-FIG. 12 has a fluid exchange system with various pathways, passages, lumens, channels, reservoirs, etc., for fluid communication, exchange, transfer, etc., among various elements, chambers, components, parts, devices, systems, etc., of the system 200. Moreover, similar to the above-described multi-chamber combining and/or delivery system 100 illustrated in FIG. 1-FIG. 7, the multi-chamber combining and/or delivery system 200 illustrated in FIG. 8-FIG. 12 has a vial adaptor 250 configured to provide various features and functions with respect to the fluid communications established by the fluid exchange system of the multi-chamber combining and/or delivery system 200. Like the above-described vial adaptor 150, features and functions provided by the vial adaptor 250 include, without limitation, fluidly coupling two or more chambers of a multi-chamber combining and/or delivery system; allowing for venting of the system (e.g., venting of at least one of the chambers of the multi-chamber system); facilitating purging of materials from at least one of the chambers of the multi-chamber system; etc.

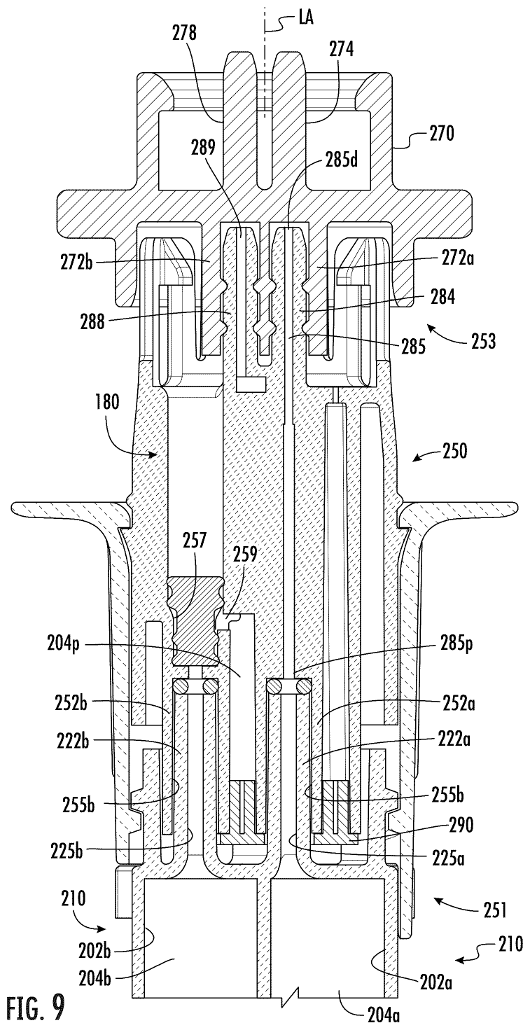

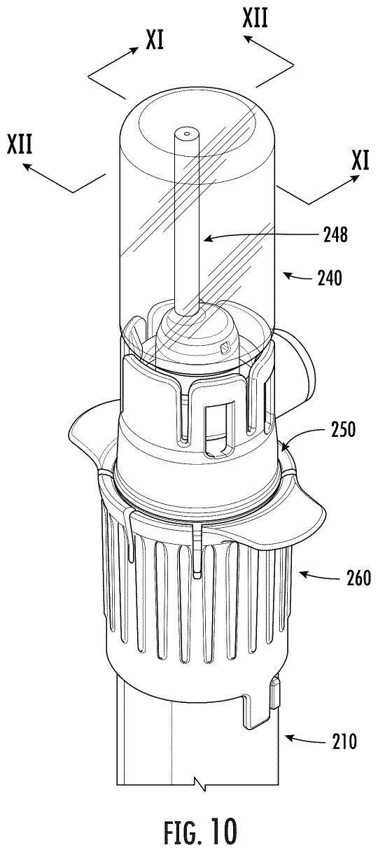

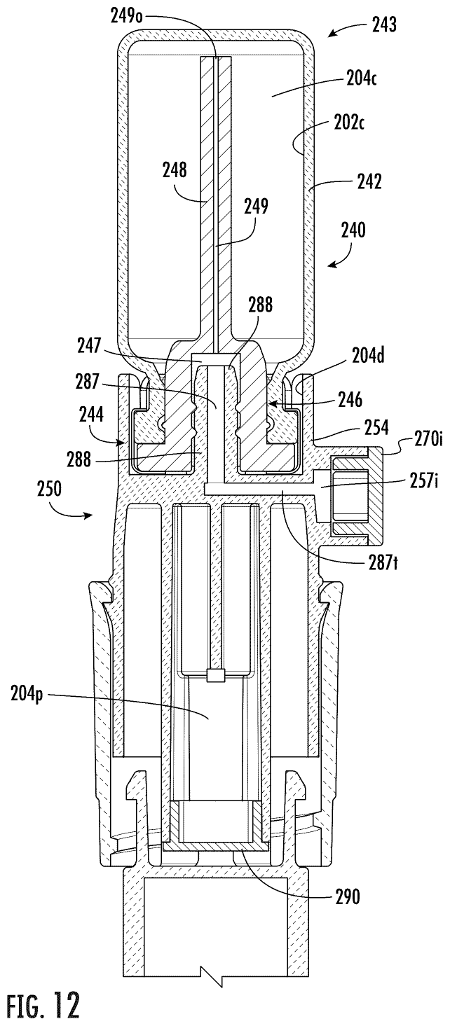

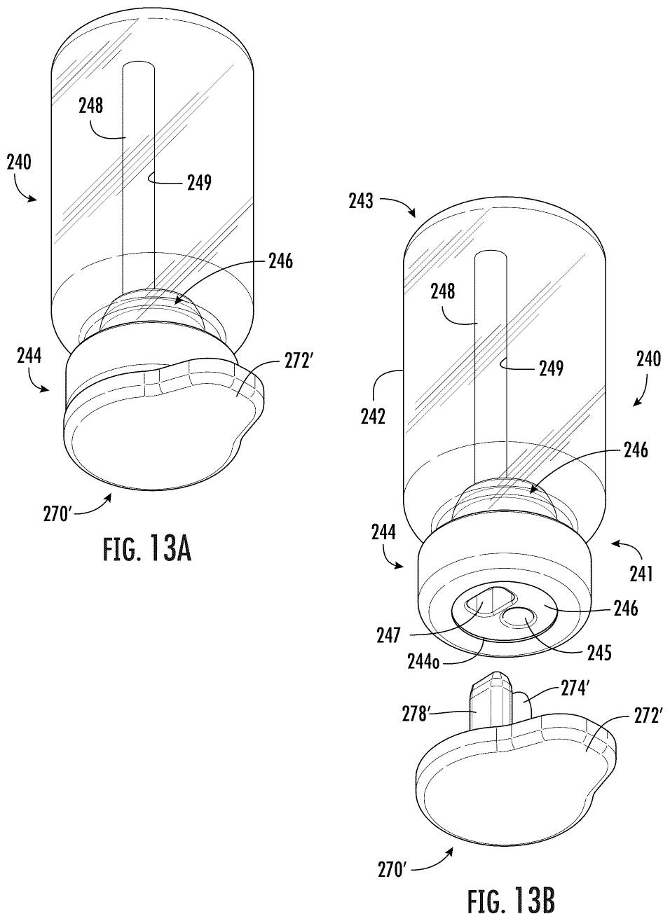

It will be appreciated that the vial adaptor 250 described with reference to FIG. 8-FIG. 12 may be used with a first injectable material transfer device 210 similar to the first injectable material transfer device 110 illustrated in FIG. 1-FIG. 6. Because the proximal portion of the first injectable material transfer device 210 is substantially the same as the equivalent proximal portion of the first injectable material transfer device 110 illustrated in FIG. 1-FIG. 6, only the distal portion of the first injectable material transfer device 210 fluidly coupled with the vial adaptor 250 is illustrated in FIG. 8-FIG. 12, and reference is made to FIG. 1 and FIG. 2 with regard to elements, structures, features, etc., of the proximal. Additionally, it will be appreciated that although the sleeve lock 260 of the multi-chamber combining and/or delivery system 200 illustrated in FIG. 8, FIG. 9, FIG. 10, FIG. 12, and FIG. 13 is not identical to the sleeve lock 160 illustrated in FIG. 1-FIG. 6, the sleeve locks 160, 260 both couple the first injectable material transfer device 110 with a vial adaptor 150 or a vial adaptor 250. Reference is therefore made to the above-discussion of the sleeve lock 160 of the above-described multi-chamber combining and/or delivery system 100 illustrated in FIG. 1-FIG. 7, and further differences between the sleeve locks 160, 260 may be appreciated with reference to the drawings of the present application, as well as with reference to the above-incorporated co-pending provisional patent application [ATTORNEY DOCKET 2001.3126100], as well as with reference to co-pending provisional patent application titled DEVICES, SYSTEMS, AND METHODS FOR COMBINING AND/OR DELIVERING INJECTABLE MATERIALS, and filed on even date herewith [ATTORNEY DOCKET 2001.3125100], which application also is hereby incorporated by reference herein in its entirety and for all purposes.

Turning to FIG. 8, and the cross-sectional view along line IX-IX thereof illustrated in FIG. 9, an example of an embodiment of a vial adaptor 250 is illustrated fluidly coupled with a first injectable material transfer device 210 of the illustrated example of an embodiment of a multi-chamber combining and/or delivery system 200. The vial adaptor 250 includes nozzle ports 252a, 252b and fluid exchange lumens 255a, 255b configured to be fluidly engaged with nozzles 222a, 222b of the first injectable material transfer device 210, in a manner similar to as described above with respect to the example of an embodiment of a vial adaptor 150 and first injectable material transfer device 110 illustrated in FIG. 1-FIG. 6. Generally, because the fluid coupling of the first injectable material transfer device 210 and the proximal end 251 of the example of an embodiment of a vial adaptor 250 illustrated in FIG. 8-FIG. 12 is substantially the same as the above-described fluid coupling of the first injectable material transfer device 110 and the example of an embodiment of a vial adaptor 150 illustrated in FIG. 1-FIG. 6, reference is made to the above descriptions of the vial adaptor 150 and first injectable material transfer device 110 as applicable, mutatis mutandis, to the vial adaptor 250 and first injectable material transfer device 210 illustrated in FIG. 8-FIG. 12

Despite similarities between the proximal end 151 of the vial adaptor 150 illustrated in FIG. 1-FIG. 7 and the proximal end 251 of the vial adaptor 250 illustrated in FIG. 8-FIG. 12, the vial adaptor 250 does not have a distal end 253 similar to the distal end 153 of the vial adaptor 150. Nonetheless, like the example of an embodiment of a vial adaptor 150 illustrated in FIGS. 1-7, the vial adaptor 250 illustrated in FIG. 8-FIG. 12 provides various fluid exchange pathways, passages, lumens, channels, reservoirs, etc., facilitating fluid communication and/or fluid transfer between at least a first chamber 202a of the multi-chamber combining and/or delivery system 200, and at least a third chamber 202c of a multi-chamber combining and/or delivery system 200 formed in accordance with various principles of the present disclosure. The third chamber 202c may be defined in a vial 240 positioned within a chamber defined by the vial adaptor 250 which may be considered a fourth chamber 202d of the multi-chamber combining and/or delivery system 200 (as illustrated in FIG. 10-FIG. 12). The first chamber 202a may thus be considered to be fluidly coupled with the fourth chamber 202d in addition to the third chamber 202c.

Like the above-described multi-chamber combining and/or delivery system 100, an overall fluid exchange system is defined with respect to the first injectable material transfer device 210, the vial adaptor 250, and the vial 240. The overall fluid exchange system defines various lumens for fluid communication, exchange, transfer, etc., among the various chambers, elements, devices, systems, etc., of the multi-chamber combining and/or delivery system 200, as illustrated in FIG. 8-FIG. 12. Like the above-described example of an embodiment of a vial adaptor 150 illustrated in FIG. 1-FIG. 7, various elements, features, components, portions, etc., of the example of an embodiment of a vial adaptor 250 illustrated in FIG. 8-FIG. 12 may be considered to form a part of the overall fluid exchange system of the multi-chamber combining and/or delivery system 200. However, instead of a fluid exchange device 180, the vial adaptor 250 includes fluid exchange nozzles 280 which may be considered to be part of the overall fluid exchange system of the multi-compartment combining and/or delivery system 200.

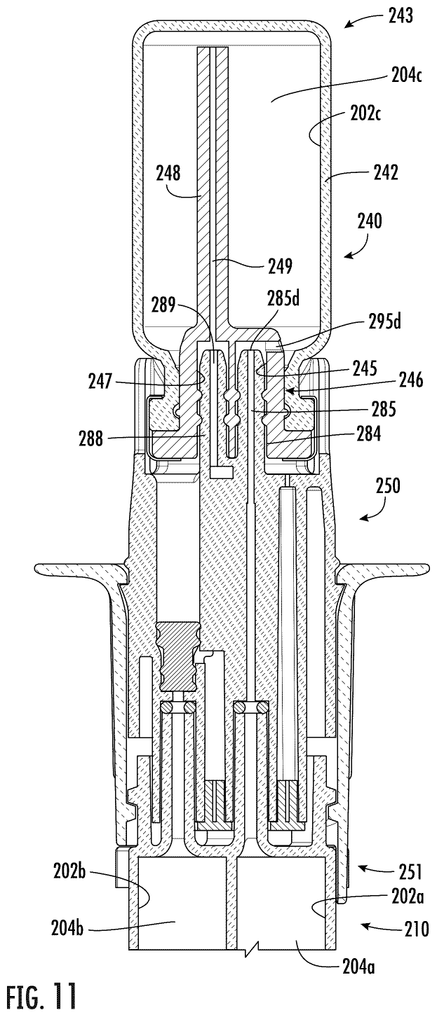

Once a vial 240 is fluidly coupled with respect to the distal end 253 of the vial adaptor 250, such as illustrated in FIG. 10, the fluid exchange nozzles 280 of the vial adaptor 250 may establish fluid communication between the first chamber 202a within the first injectable material transfer device 210 and the third chamber 202c within the vial 240. More particularly, as may be appreciated with reference to FIG. 11, showing a cross-sectional view along line XI-XI in FIG. 10, the example of an embodiment of fluid exchange nozzles 280 includes a fluid exchange nozzle 284 and a venting nozzle 288 which may be considered akin to the fluid exchange spike 184 and the distal extension 188, respectively, of the fluid exchange device 180 illustrated in FIG. 4-FIG. 6. As may be further appreciated with reference to FIG. 11, the fluid exchange nozzle 284 defines a fluid exchange lumen 285 therethrough via which fluid may be exchanged between the first chamber 202a and the third chamber 202c. And, the venting nozzle 288 defines a venting lumen 289 facilitating venting of the vial 240 as material is withdrawn/aspirated from the third chamber 202c, such as illustrated in FIG. 12. As with the fluid exchange system 180 and protective cap 170 of FIG. 1-FIG. 6, a protective cap 270 may be provided to cover the fluid exchange nozzles 280, such as illustrated in FIG. 8. As may be appreciated with reference to FIG. 9, the illustrated example of an embodiment of a protective cap 270 includes cap ports 272a, 272b configured to receive the vial adaptor nozzles 284, 288, such as to protect the vial adaptor nozzles 284, 288, and/or to seal the lumens 285, 289 respectively defined through the vial adaptor nozzles 284, 288.

The structures defining the fluid exchange lumen 285 and the venting lumen 289 of the fluid exchange nozzles 280 of the example of an embodiment of a vial adaptor 250 illustrated in FIG. 8-FIG. 12 are different from the corresponding structures of the fluid exchange device 180 of the vial adaptor 150 illustrated in FIG. 4-FIG. 7 in order to fluidly communicate with a modified vial 240. An example of an embodiment of a modified vial 240 defining a third chamber 202c of the multi-chamber combining and/or delivery system 200 illustrated in FIG. 8-FIG. 12 is illustrated in isolation in FIG. 13A and FIG. 13B. As may be appreciated, the illustrated example of an embodiment of a vial 240 includes a vial cap 244 with a generally central open region 2440 allowing access to a plug or stopper 246 positioned within the open end 241 of the vial body 242, as may be appreciated with reference to FIG. 11, FIG. 12, and FIG. 13B. Although the illustrated example of an embodiment of a vial cap 244 may be similar to the vial cap 144 of the above-described vial 140, the stopper 246 differs from the stopper 146 of the above-described vial 140. Instead of being a pierceable stopper, like the stopper 146 of the above-described vial 140, the stopper 246 of the modified vial 240 defines two access ports 245, 247 therethrough, facilitating fluid transfer and venting, respectively, when in fluid communication with the fluid exchange nozzles 280. As such, the modified vial 240 and the modified vial stopper 244b illustrated in FIG. 13A and FIG. 13B, as well as the cross-sectional view in FIG. 12, may be considered a part of the overall fluid exchange system of the multi-chamber combining and/or delivery system 200 as illustrated in FIG. 10-FIG. 12.

Details of the fluid exchange facilitated by the port 245 of the modified stopper 246 may be appreciated with reference to FIG. 11 and FIG. 13B. The port 245 may be considered a fluid exchange port 245 configured to receive the fluid exchange nozzle 284 of the fluid exchange nozzles 280 of the vial adaptor 250. The fluid exchange lumen 285 defined through the fluid exchange nozzle 284 is in fluid communication with the fluid exchange port 245 defined in the stopper 246, as illustrated in FIG. 11, to fluidly communicate the first chamber 202a and the third chamber 202c. More particularly, the fluid exchange lumen 285 extends from a distal end 285d thereof (extending out the distal end of the fluid exchange nozzle 284), through the vial adaptor 250, to a proximal end 285p thereof. The proximal end 285p of the fluid exchange lumen 285 is in fluid communication with the first nozzle port 252a of the vial adaptor 250 and a first fluid exchange lumen 225a defined through the first nozzle 222a of the first injectable material transfer device 210 and in fluid communication with the first chamber 202a. Optionally, the stopper fluid exchange port 245 has a transversely extending distal opening 245d fluidly communicating with the third chamber 202c. Via such fluid exchange pathways, a first component 204a may be ejected into the third chamber 202c from the first chamber 202a; a third component 204c may be aspirated out of the third chamber 202c into the first chamber 202a; and/or a precursor 204d (formed upon combing a first component 204a injected into the third chamber 202c with the third component 204c within the third chamber 202c) may be aspirated out of the third chamber 202c and into the first chamber 202a.

As noted above, it may be desirable to vent the third chamber 202c if material is aspirated/withdrawn therefrom. The port 247 of the modified stopper 246 of the modified vial 240 may be considered a venting port 247. As may be appreciated with reference to FIG. 12 and FIG. 13B, the venting port 247 is in fluid communication with a stopper distal extension 248 which extends distally from the stopper 246 into the third chamber 202c within the vial 240. When the vial 240 is inverted as in FIG. 12, a venting lumen 249 defined through the stopper distal extension 248 fluidly communicates the venting port 247 with the empty space within the vial 240 as material is withdrawn therefrom. It will be appreciated that the venting outlet 2490 of the stopper distal extension 248 extends sufficiently beyond the transversely extending distal opening 245d of the stopper fluid exchange port 245 and toward the distal end 243 of the vial 240 (i.e., distally into the third chamber 202c than the distal end 245d opening of the stopper fluid exchange port 245 extends) to assure communication with empty space within the vial 240 (e.g., when the vial 240 is inverted, as illustrated in FIG. 9), rather than with the third component 204c within the vial 240. As the empty space increases (as material is aspirated/withdrawn from the third chamber 202c), pressure is equalized therein by a venting lumen inlet 257i defined in the side wall 254 of the vial adaptor 250. More specifically, the stopper venting port 247 fluidly communicates the stopper distal extension venting lumen 249 (fluidly communicating with the empty space within the third chamber 202c) with a venting lumen 287 defined in the venting nozzle 288 of the fluid exchange nozzles 280 of the vial adaptor 250. The nozzle venting lumen 287, in turn, is fluidly communicated with the venting lumen inlet 257i via a transverse venting lumen section 287t defined in the vial adaptor 250. The empty space within the vial 240 is thus vented to atmosphere via the lumens 249, 287, 287t and the venting lumen inlet 257i, and pressure within the third chamber 202c is equalized as material is aspirated/withdrawn therefrom. An optional vent cap 270i (which itself may be vented in a manner such as known those of ordinary skill in the art) may be provided to cover the venting lumen inlet 257i if desired.

To limit undesired fluid communication with the third chamber 202c defined within the modified vial 240 prior to being fluidly coupled with the vial adaptor 250 of the multi-chamber combining and/or delivery system 200, a protective cap 270′ may be seated over the plug access ports 245, 247 to prevent inadvertent leakage or other unintended fluid communication from/to the third chamber 202c within the modified vial 240, such as illustrated in FIG. 13A. The example of an embodiment of a protective cap 270′ illustrated in FIG. 13B has a plug extension 274′ positioned, sized, shaped, configured, and/or dimensioned to extend into and plug the fluid exchange port 245, and/or a plug extension 278′ positioned, sized, shaped, configured, and/or dimensioned to extend into and plug the venting port 247. Additionally or alternatively, the protective cap 270′ may include a grasping section 272′ configured to facilitate grasping and/or pulling on the protective cap 270′ to remove the protective cap 270′ from the vial 240. The grasping section 272′ may be in the form of a radially-outwardly projecting flange and/or an axially extending projection/wing, such as described above with respect to the grasping section 172 of the protective cap 170 of the multi-chamber combining and/or delivery system 100 (as illustrated in FIG. 1, FIG. 2, and FIG. 4). In some embodiments, the protective cap 270 may be configured with extensions 274, 278 sized, shaped, and dimensioned similar to the vial adaptor nozzles 284, 288, but without lumens extending therethrough. In such embodiment, the extensions 274, 278 may be inserted within the ports 245, 247 of the vial 240 in place of the plug extensions 274′, 278′ of the protective cap 270′. As such, the protective cap 270 may be seated with respect to the vial adaptor 250 to cover the fluid exchange nozzles 280, as well as seated with respect to the vial 240 to cover the ports 245, 247 thereof before the multi-chamber combining and/or delivery system 200 is ready for use (e.g., to combine and/or deliver materials to a patient).

In accordance with various further principles of the present disclosure, like the example of an embodiment of a multi-chamber combining and/or delivery system 100 illustrated in FIG. 1-FIG. 7, the fluid exchange system of the example of an embodiment of a multi-chamber combining and/or delivery system 200 illustrated in FIG. 8-FIG. 12 defines a purge system. The purge system includes a purge reservoir 204p defined within the vial adaptor 250, such as illustrated in FIG. 9, FIG. 11, and FIG. 12, into which excess/surplus material, and/or air (e.g., air) bubbles may be purged from the second chamber 202b. Like the above-described purge system of the multi-chamber combining and/or delivery system 100 illustrated in FIG. 1-FIG. 6, material from the second chamber 202b is ejected (such as a result of distal advancement of a plunger rod therein) through a fluid exchange lumen 225b defined through the second nozzle 222b of the first injectable material transfer device 210, and through the second nozzle port 252b and into the second fluid exchange lumen 255b defined in the vial adaptor 250. In some aspects, material from the second chamber 202b is ejected at the same time material is ejected from the first chamber 202a into the third chamber 202c.

In some embodiments, such as illustrated in FIG. 11, a valve seal 256 is positioned within a valve lumen 259 defined within the vial adaptor 250 (e.g., axially therealong) and may be sized, shaped, configured, and/or dimensioned to prevent unwanted flow of materials with respect to the second chamber 202b (within the first injectable material transfer device 210). Similar to the above-described valve seal 156, the valve seal 256 is slidable within the valve lumen 259 between a sealing position sealing fluid communication with respect to the second chamber 202b, and a purge position allowing fluid communication from the second chamber 202b to the purge reservoir 204p. Upon sufficient pressure created within the second chamber 202b (such as by advancement of a plunger rod therein), the valve seal 256 is moved sufficiently distally in the valve lumen 259 to the purge position. In the purge position, the second fluid exchange lumen 255b (which is in fluid communication with the second chamber 202b via the second fluid exchange lumen 225b defined in the second barrel nozzle 222b) is fluidly communicated with a purge channel 259p extending from the valve lumen 259 to the purge reservoir 204p. As may be appreciated with reference to the cross-sectional views of FIG. 9, FIG. 11, and FIG. 12, in some embodiments, the nozzle ports 252a, 252b are not symmetrically positioned with respect to the longitudinal axis LA of the multi-chamber combining and/or delivery system 200, such as illustrated in FIG. 9 and FIG. 11. Such position may facilitate formation of the purge reservoir 204p within the vial adaptor 250 by generally limiting the cross-sectional extent of the purge reservoir 204p to around the first nozzle port 252a without also extending fully around the second nozzle port 252b. Additionally or alternatively, such asymmetry also facilitates straight-line construction for fluid flow from the chamber to the vial. As may further be appreciated with reference to the cross-sectional views of FIG. 9, FIG. 11, and FIG. 12, the illustrated example of an embodiment of a vial adaptor 250 includes a reservoir cap 290 defining a bottom/proximal wall of the purge reservoir 204p. Additionally or alternatively, the reservoir cap 290 encloses the purge reservoir 204p to retain the purged materials within the purge reservoir 204p within the vial adaptor 250, such as to prevent spillage therefrom (e.g., upon separation of the vial adaptor 250 from the first injectable material transfer device 210). In some embodiments, a purge reservoir vent hole 204i is defined in the vial adaptor 250 to vent the purge reservoir 204p, such as to prevent buildup of pressure which may otherwise occur upon purging air from the second chamber 202b into the purge reservoir 204p.

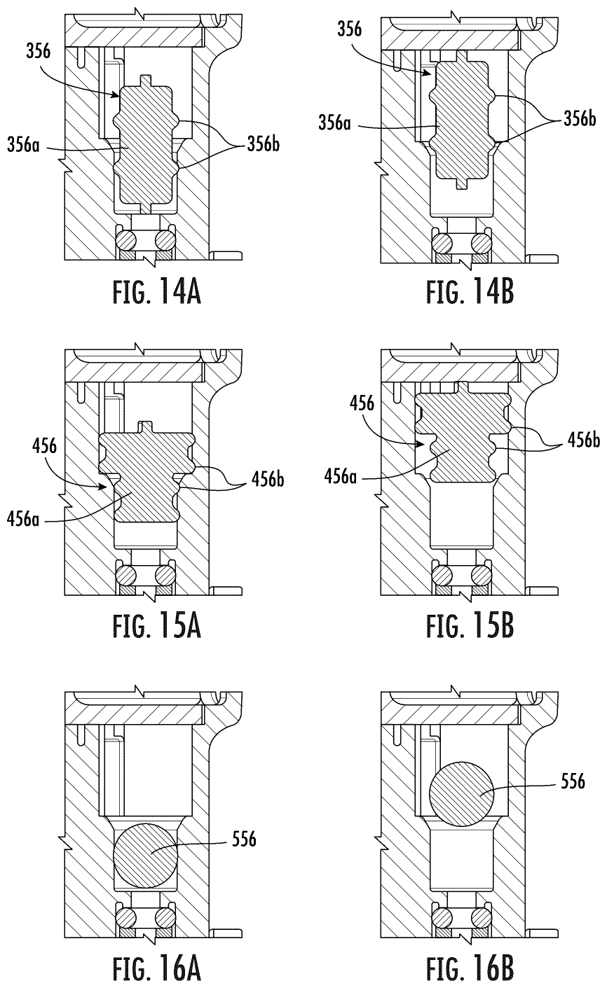

As may be appreciated, like the above-described valve seal 156, the valve seal 256 may be a one-way valve. Moreover, it will be appreciated that either or both of the valve seals 156, 256 may have any of a variety of configurations suitable for a purge system such as described above. For instance, as may be appreciated with reference to the example of an embodiment of a valve seal 156 illustrated in FIG. 4 and FIG. 5, and a further example of an embodiment of a valve seal 356 illustrated in FIG. 14A and FIG. 14B, a valve of a purge system formed in accordance with various principles of the present disclosure may have a body portion 156a, 356a with a generally cylindrical cross-sectional shape (with a generally constant outer diameter), and one or more sealing fins 156b, 356b extending circumferentially around and radially outwardly from the body portion 156a, 356a. The valves 156, 356 may be positioned in a respective valve lumen to move between a sealing position (such as illustrated in FIG. 4 and FIG. 14A) in which the sealing fins 156b, 356b seal fluid communication between the valve lumen and the purge channel leading to the purge reservoir, and a purge position (such as illustrated in FIG. 5 and FIG. 14B) in which the valve lumen is in fluid communication with the purge channel to fluidly communicate the second chamber of the associated injectable material transfer device with the purge reservoir of the associated vial adaptor (via the valve lumen, and purge channel). It will be appreciated that the scaling fins 156b, 356b are positioned, sized, shaped, configured, and/or dimensioned with respect to the valve lumen and the purge channel to allow fluid to pass therethrough and/or therebetween. As may be appreciated, the valve lumen need not have a constant diameter (such as may be appreciated upon comparison of the valve lumen 155b illustrated in FIG. 4 and FIG. 5 and the valve lumen 259 illustrated in FIG. 7, FIG. 9, FIG. 11). Moreover, the purge channel may have any of a variety of configurations, such as may be appreciated upon comparison of the examples of embodiments illustrated in FIG. 4, FIG. 5, FIG. 7, FIG. 9, FIG. 11).

As may be appreciated, various modifications to the above-described valve seal may be made in accordance with various principles of the present disclosure without departing from the scope and spirit of the present disclosure. For instance, a valve seal formed in accordance with various principles of the present disclosure need not have a valve body with a constant diameter (e.g., like the examples of embodiments illustrated in FIG. 4, FIG. 5, FIG. 14A, and FIG. 14B). Instead, valve seals formed in accordance with various principles of the present disclosure may have more than one diameter (e.g., stepped, tapered, etc.). In FIG. 9 and FIG. 11, the illustrated example of an embodiment of a valve seal 256 has a smaller-diameter portion closer to the proximal end 251 of the vial adaptor 250, and a larger-diameter portion closer to the distal end 253 of the vial adaptor 250. Another example of an embodiment of a valve seal 456 with a valve body 456a with a stepped diameter is illustrated in FIG. 15A and FIG. 15B. A valve seal 256, 456 with a stepped diameter may advantageously be used in a valve lumen with a stepped diameter. As the valve seal 256, 456 moves distally from the narrower valve lumen section to the wider valve lumen section (e.g., from a position as in FIG. 9 to a position as in FIG. 11, or from a position as in FIG. 15A to a position as in FIG. 15B), the narrower valve body portion moves into the wider valve lumen portion to facilitate fluid flow through a purge channel fluidly communicating with the wider valve lumen portion. As may be appreciated with reference to the example of an embodiment of a valve seal 456 illustrated in FIG. 15A and FIG. 15B, scaling fins 456b similar to the above-described sealing fins 156b, 356b may extend circumferentially around and radially outwardly from the seal body 456a for similar sealing effects as described above with reference to the sealing fins 156b, 356b.

As may be appreciated with reference to FIG. 16A and FIG. 16B, instead of having a generally cylindrical body (such as the generally cylindrical valve seal body portion 156a, 256a, 356a, 456a described above), a valve seal 556 formed in accordance with various principles of the present disclosure may be generally spherical. Similar to the valve seals 156, 256, 356, 456, the spherical valve seals 556 may be positioned in a stepped valve lumen to move between a sealing position seated with respect to a narrower valve lumen portion (as illustrated in FIG. 16A) and a purge position within a wider valve lumen having a diameter wider than that of the valve seal 556 (as illustrated in FIG. 16B) to allow fluid communication of the narrower portion of the valve lumen (in fluid communication with a second chamber of the associated multi-chamber combining and/or delivery system) with a purge channel leading to a purge reservoir.

It will be appreciated that the example of an embodiment of a multi-chamber combining and/or delivery system 100 illustrated in FIG. 1-FIG. 7, and the example of an embodiment of a multi-chamber combining and/or delivery system 200 illustrated in FIG. 8-FIG. 13B establish similar fluid communications despite several differences therebetween. For instance, various features of the vial adaptor base portion 190 and the fluid exchange device 180 of the vial adaptor 150 of FIG. 1-FIG. 7 are present in different configurations in the vial adaptor 250 of FIG. 8-FIG. 12. For instance, as may be appreciated with reference to the illustrations in FIG. 11 and FIG. 12 of the vial adaptor 250 in fluid communication with an example of an embodiment of a vial 240, the distal end 253 of the vial adaptor 250 defines a fourth chamber 202d of the multi-chamber combining and/or delivery system 200 which is significantly shorter than the fourth chamber 102d of the multi-chamber combining and/or delivery system 100 illustrated in FIG. 1-FIG. 6. In particular, instead of being sized, like the fourth chamber 102d of the vial adaptor 150, to receive most if not substantially all of the length of a vial 140, the fourth chamber 202d of the vial adaptor 250 is sized to receive a cap portion 242 of a vial 240, without a significant portion of the vial body 242. As such, fluid engagement between a vial adaptor 150 and a vial 140 of the example of an embodiment illustrated in FIG. 1-6 occurs generally at a proximal end 151 of the vial adaptor 150, whereas fluid engagement between a vial adaptor 250 and a vial 240 of the example of an embodiment illustrated in FIG. 8-12 occurs generally at a distal end 253 of the vial adaptor 250.

In view of the above, it will be appreciated that a multi-chamber combining and/or delivery system with a vial adaptor formed in accordance with various principles of the present disclosure simplifies devices, systems, and methods for combining and/or delivering an injectable material to a patient and/or reduces (if not eliminates) human error occurring with the use of complex prior systems.

Further in view of the above, it should be understood that the various embodiments illustrated in the figures have several separate and independent features, which each, at least alone, has unique benefits which are desirable for, yet not critical to, the presently disclosed devices, systems, and methods. Therefore, the various separate features described herein need not all be present in order to achieve at least some of the desired characteristics and/or benefits described herein. For instance, only one of the various features described above may be present in a device or system formed in accordance with various principles of the present disclosure. Alternatively, one or more of the features described with reference to one embodiment can be combined with one or more of the features of any of the other embodiments provided herein. That is, any of the features described herein can be mixed and matched to create hybrid designs, and such hybrid designs are within the scope of the present disclosure.

It is to be understood by one of ordinary skill in the art that the present discussion is a description of illustrative examples of embodiments only, and is not intended as limiting the broader aspects of the present disclosure. All apparatuses and methods discussed herein are examples of apparatuses and/or methods implemented in accordance with one or more principles of this disclosure. These examples are not the only way to implement these principles but are merely examples, not intended as limiting the broader aspects of the present disclosure. Thus, references to elements or structures or features in the drawings must be appreciated as references to examples of embodiments of the disclosure, and should not be understood as limiting the disclosure to the specific elements, structures, or features illustrated. Other examples of manners of implementing the disclosed principles will occur to a person of ordinary skill in the art upon reading this disclosure. It should be apparent to those of ordinary skill in the art that variations can be applied to the disclosed devices, systems, and/or methods, and/or to the sequence of steps of the method described herein without departing from the concept, spirit, and scope of the disclosure. It will be appreciated that various features described with respect to one embodiment typically may be applied to another embodiment, whether or not explicitly indicated. The various features hereinafter described may be used singly or in any combination thereof. Therefore, the present invention is not limited to only the embodiments specifically described herein, and all substitutes and modifications apparent to those skilled in the art are deemed to be within the spirit, scope, and concept of the disclosure as defined by the appended claims. Various further benefits of the various aspects, features, components, and structures of devices, systems, and methods such as described above, in addition to those discussed above, may be appreciated by those of ordinary skill in the art.

The foregoing discussion has broad application and has been presented for purposes of illustration and description and is not intended to limit the disclosure to the form or forms disclosed herein. It will be understood that various additions, modifications, and substitutions may be made to embodiments disclosed herein without departing from the concept, spirit, and scope of the present disclosure. In particular, it will be clear to those skilled in the art that principles of the present disclosure may be embodied in other forms, structures, arrangements, proportions, and with other elements, materials, and components, without departing from the concept, spirit, or scope, or characteristics thereof. For example, various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. While the disclosure is presented in terms of embodiments, it should be appreciated that the various separate features of the present subject matter need not all be present in order to achieve at least some of the desired characteristics and/or benefits of the present subject matter or such individual features. One skilled in the art will appreciate that the disclosure may be used with many modifications or modifications of structure, arrangement, proportions, materials, components, and otherwise, used in the practice of the disclosure, which are particularly adapted to specific environments and operative requirements without departing from the principles or spirit or scope of the present disclosure. For example, elements shown as integrally formed may be constructed of multiple parts or elements shown as multiple parts may be integrally formed, the operation of elements may be reversed or otherwise varied, the size or dimensions of the elements may be varied. Similarly, while operations or actions or procedures are described in a particular order, this should not be understood as requiring such particular order, or that all operations or actions or procedures are to be performed, to achieve desirable results. Additionally, other implementations are within the scope of the following claims. In some cases, the actions recited in the claims can be performed in a different order and still achieve desirable results. The presently disclosed embodiments are therefore to be considered in all respects as illustrative and not restrictive, the scope of the claimed subject matter being indicated by the appended claims, and not limited to the foregoing description or particular embodiments or arrangements described or illustrated herein. In view of the foregoing, individual features of any embodiment may be used and can be claimed separately or in combination with features of that embodiment or any other embodiment, the scope of the subject matter being indicated by the appended claims, and not limited to the foregoing description.

In the foregoing description and the following claims, the following will be appreciated. The phrases “at least one”, “one or more”, and “and/or”, as used herein, are open-ended expressions that are both conjunctive and disjunctive in operation. The terms “a”, “an”, “the”, “first”, “second”, etc., do not preclude a plurality. For example, the term “a” or “an” entity, as used herein, refers to one or more of that entity. As such, the terms “a” (or “an”), “one or more” and “at least one” can be used interchangeably herein. As used in this specification and the appended claims, the term “or” is generally employed in its sense including “and/or” unless the content clearly dictates otherwise. As used herein, the conjunction “and” includes each of the structures, components, features, or the like, which are so conjoined, unless the context clearly indicates otherwise, and the conjunction “or” includes one or the others of the structures, components, features, or the like, which are so conjoined, singly and in any combination and number, unless the context clearly indicates otherwise. All directional references (e.g., proximal, distal, upper, lower, upward, downward, left, right, lateral, longitudinal, front, back, top, bottom, above, below, vertical, horizontal, radial, axial, clockwise, counterclockwise, and/or the like) are only used for identification purposes to aid the reader's understanding of the present disclosure, and/or serve to distinguish regions of the associated elements from one another, and do not limit the associated element, particularly as to the position, orientation, or use of this disclosure. Connection references (e.g., attached, coupled, connected, engaged, joined, etc.) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another.

The following claims are hereby incorporated into this Detailed Description by this reference, with each claim standing on its own as a separate embodiment of the present disclosure. In the claims, the terms “comprises”, “comprising”, “includes”, and “including” do not exclude the presence of other elements, components, features, groups, regions, integers, steps, operations, etc. Additionally, although individual features may be included in different claims, these may possibly advantageously be combined, and the inclusion in different claims does not imply that a combination of features is not feasible and/or advantageous. In addition, singular references do not exclude a plurality. Reference signs in the claims are provided merely as a clarifying example and shall not be construed as limiting the scope of the claims in any way.

What is claimed is:

1. A vial adaptor comprising:
a proximal end configured to be fluidly coupled with a material transfer device defining a first chamber of a multi-chamber system;
a distal end configured to be fluidly coupled with a separate chamber of the multi-chamber system; and
a fluid exchange system defined between said vial adaptor proximal end and said vial adaptor distal end, and including:
a fluid exchange lumen extending through said vial adaptor distal end to fluidly communicate the separate chamber fluidly coupled with said vial adaptor distal end with the first chamber fluidly coupled with said vial adaptor proximal end; and
a venting lumen extending through said vial adaptor distal end to vent the separate chamber fluidly coupled with said vial adaptor distal end, wherein said venting lumen is fluidly isolated from said fluid exchange lumen, and fluidly communicates with a venting lumen inlet defined in a wall of said vial adaptor.

2. The vial adaptor of claim 1, wherein:
said proximal end of said vial adaptor defines a first port configured to receive and to be fluidly communicated with a first nozzle of the material transfer device defining the first chamber of the multi-chamber system, whereby said fluid exchange lumen is fluidly communicated with the first chamber of the multi-chamber system via said vial adaptor first port and the material transfer device first nozzle; and
said distal end of said vial adaptor defines a vial-receiving chamber configured to receive a vial defining the separate chamber of the multi-chamber system.

3. The vial adaptor of claim 2, wherein:
said fluid exchange lumen and said venting lumen are defined in a vial adaptor base portion; and
said vial-receiving chamber extends distally from said vial adaptor base portion to define a vial-receiving chamber sized to receive the body of the vial defining the separate chamber.

4. The vial adaptor of claim 3, further comprising a fluid exchange device comprising:
a fluid exchange device base portion;
a fluid exchange spike extending distally from said fluid exchange device base portion and defining said fluid exchange lumen therethrough with a distal end of said fluid exchange lumen extending through said fluid exchange spike to be positioned within said vial-receiving chamber and a proximal end of said fluid exchange lumen extending through said fluid exchange device base portion; and
a distal extension extending distally from said fluid exchange device base portion and defining said venting lumen therethrough with a venting outlet positioned distal to said distal end of said fluid exchange lumen in said fluid exchange spike.

5. The vial adaptor of claim 4, wherein:
said vial adaptor base portion defines a fluid exchange channel forming a base fluid exchange lumen with said fluid exchange device base portion, and a venting channel forming a base venting lumen with said fluid exchange device base portion;
said base fluid exchange lumen is in fluid communication with said fluid exchange lumen and said first port defined in said proximal end of said vial adaptor; and
said base venting lumen is in fluid communication with said venting lumen and said venting lumen inlet.

6. The vial adaptor of claim 4, wherein said distal extension of said fluid exchange device has a sharp distal end for piercing a stopper of the vial defining the separate chamber to facilitate passage of said fluid exchange spike through the vial stopper and into the separate chamber, and said venting outlet of said fluid exchange device distal extension is defined in said sharp distal tip of said fluid exchange device distal extension.

7. The vial adaptor of claim 2, wherein:
said vial adaptor further comprises a fluid exchange nozzle and a venting nozzle extending distally from said vial adaptor distal end and configured to be fluidly coupled with a fluid exchange port and a venting port, respectively, defined in a stopper of the vial received in said vial-receiving chamber;
said fluid exchange lumen extends through said fluid exchange nozzle to fluidly communicate with the separate chamber; and
said venting lumen extends through said venting nozzle to fluidly communicate with a distal extension extending within the separate chamber distally beyond the fluid exchange port in the vial stopper.

8. The vial adaptor of claim 1, wherein:
said proximal end of said vial adaptor defines a second port configured to receive and to be fluidly communicated with a second nozzle of the material transfer device; and
said vial adaptor further comprises a purge reservoir in fluid communication with said second port, whereby material from a second chamber defined in the material transfer device may be fluidly communicated, via the second nozzle and said second port, with said purge reservoir.

9. The vial adaptor of claim 8, wherein said purge reservoir is defined in a vial adaptor base portion and is fluidly isolated from said fluid exchange lumen and said venting lumen.

10. The vial adaptor of claim 8, wherein:
said vial adaptor further includes a reservoir cap positioned adjacent said proximal end of said vial adaptor and enclosing said purge reservoir within said vial adaptor; and
said purge reservoir is fluidly isolated from said fluid exchange lumen and said venting lumen.

11. A multi-chamber combining and/or delivery system comprising:
a material transfer device defining a first chamber therein; and
a vial adaptor defining a vial-receiving chamber;
wherein:
said vial adaptor has a proximal end defining a first nozzle port;
said multi-chamber device has a first nozzle configured to be fluidly coupled with said first vial adaptor nozzle port;
said vial adaptor has a distal end defining a fluid exchange lumen fluidly communicating with said first vial adaptor nozzle port and said first multi-chamber device nozzle; and
said vial adaptor distal end further defines a venting lumen fluidly isolated from said fluid exchange lumen and extending from a venting lumen inlet defined in a wall of said vial adaptor to said vial adaptor distal end.

12. The system of claim 11, further comprising a fluid exchange device comprising:
a fluid exchange device base portion;
a fluid exchange spike extending distally from said fluid exchange device base portion and defining said fluid exchange lumen therethrough with a distal end of said fluid exchange lumen extending through said fluid exchange spike to be positioned within said vial-receiving chamber and a proximal end of said fluid exchange lumen extending through said fluid exchange device base portion to fluidly communicate with said first vial adaptor nozzle port; and
a distal extension extending distally from said fluid exchange device base portion and defining said venting lumen therethrough with a venting outlet positioned within said vial-receiving chamber distal to said distal end of said fluid exchange lumen in said fluid exchange spike.

13. The system of claim 11, further comprising a vial having a vial body with an open end, and a vial stopper positioned within the vial body open end, wherein:
said vial body defines a separate chamber positionable within said vial-receiving chamber defined by said vial adaptor;
said vial stopper defines a fluid exchange port and a venting port therethrough in fluid communication with said separate chamber defined within said vial body;
said vial adaptor further comprises a fluid exchange nozzle extending distally from said vial adaptor distal end and configured to be fluidly coupled with said separate chamber via said vial stopper fluid exchange port, and a venting nozzle extending distally from said vial adaptor distal end and configured to be fluidly coupled with said separate chamber via said vial stopper venting port; and
said vial stopper further comprises a distal extension extending within said separate chamber to be positioned distal to said vial stopper fluid exchange port and within empty space within said separate chamber when said vial is inverted and material is withdrawn therefrom through said vial stopper fluid exchange port.

14. The system of claim 11, wherein:
said proximal end of said vial adaptor further defines a second nozzle port;
said multi-chamber device further defines a second chamber therein; and
said multi-chamber device has a second nozzle configured to be fluidly coupled with said second vial adaptor nozzle port to fluidly communicate said second chamber with said vial adaptor.

15. The system of claim 14, wherein said vial adaptor further defines a purge reservoir fluidly coupled with said vial adaptor second nozzle port, said second multi-chamber device nozzle, and said second chamber, and fluidly isolated from said vial adaptor fluid exchange lumen, said first vial adaptor nozzle port, said first multi-chamber device nozzle, and said first chamber.

16. A method of combining a first material contained within a first chamber and a second material contained within a separate chamber of a multi-chamber system, said method comprising:
fluidly communicating the first chamber and the separate chamber via a vial adaptor;
aspirating the material from the separate chamber into the first chamber via a fluid exchange lumen defined by the vial adaptor; and
venting the separate chamber as material is withdrawn therefrom to equalize pressure within the separate chamber via a venting lumen defined by the vial adaptor;
wherein:
the fluid exchange lumen extends from a distal end thereof into fluid communicated with the first chamber; and
the venting lumen is fluidly communicated with a venting lumen inlet defined through a wall of the vial adaptor, and has an outlet beyond the distal end of the fluid exchange lumen to be positioned within empty space within the separate chamber as material is withdrawn therefrom.

17. The method of claim 16, further comprising ejecting the first material from the first chamber, through the fluid exchange lumen defined in the vial adaptor, and into the separate chamber.

18. The method of claim 16, wherein the vial adaptor includes a fluid exchange device having a fluid exchange spike through which the vial adaptor fluid exchange lumen is defined and a distal extension through which the vial adaptor venting lumen is defined, said method further comprising:
extending the fluid exchange device fluid exchange spike through a stopper in an open end of a vial defining the separate chamber to extend a distal end of the fluid exchange lumen, defined in the fluid exchange spike, into the separate chamber; and
extending the distal extension further into the separate chamber than the distal end of the fluid exchange lumen is extended to fluidly communicate the venting lumen defined with empty space created within the separate chamber as material is withdrawn therefrom.

19. The method of claim 1, further comprising:
fluidly coupling a fluid exchange nozzle extending distally from a distal end of the vial adaptor into a fluid exchange port defined in a stopper in an open end of a vial defining the separate chamber;
fluidly coupling a venting nozzle extending distally from the distal end of the vial adaptor with the separate chamber via a venting port defined in the vial stopper; and
fluidly coupling the venting nozzle with empty space within the vial via an extension extending from the vial stopper into the separate chamber toward a closed end of the vial opposite the open end of the vial.

20. The method of claim 16, wherein:
the first chamber is defined in a multi-chamber device defining a second chamber; and
said method further comprises purging material or air from the second chamber into a purge reservoir contained within the vial adaptor.
